(19) United States
(12) Patent Application Publication
(10) Pub. No.: US 2025/0335585 A1
(43) Pub. Date: Oct. 30, 2025

(54) AUTOMATIC IDENTIFICATION OF CRITICAL ASSETS AND PROTECTIVE ACTION PRIORITIZATION

(71) Applicant: Microsoft Technology Licensing, LLC, Redmond, WA (US)

(72) Inventors: Karam Abu HANNA, Nazareth (IL); Nethanel Yitzhak COPPENHAGEN, Modiin (IL); Ram Haim PLISKIN, Rishon Lezion (IL)

(21) Appl. No.: 18/678,418

(22) Filed: May 30, 2024

Related U.S. Application Data
(60) Provisional application No. 63/640,575, filed on Apr. 30, 2024.

(51) Int. Cl. G06F 21/55; G06F 21/57

(52) U.S. Cl. CPC G06F 21/554; G06F 21/577

(57) ABSTRACT

Critical assets are identified, and protective actions are prioritized. In an aspect, configuration data associated with a first asset is received. An analysis result is generated based on an analysis of the configuration data. The first asset is determined to be a critical asset based on the analysis result. A prioritization action is performed based on the determination that the first asset is a critical asset. In a further aspect, a protective action is determined based on the analysis result. In another further aspect, a security vulnerability of the first asset is identified and resolved. In still another aspect, a protective action of the first asset is prioritized over a protective action of another asset.

### CROSS-REFERENCE TO RELATED APPLICATIONS

This application claims priority to U.S. Provisional Patent Application Ser. No. 63/640,575, filed Apr. 30, 2024, the entirety of which is incorporated by reference herein.

### BACKGROUND

Cloud computing refers to the access and/or delivery of computing services and resources, including servers, storage, databases, networking, software, analytics, and intelligence, over the Internet (“the cloud”). A cloud computing platform makes such services and resources available to user entities, referred to as “tenants,” for fees. A cloud computing platform typically supports multiple tenants, with each tenant accessing a respective portion of the services and resources simultaneously with other tenants accessing other portions of the services and resources. Such a cloud computing platform is considered “multitenant.” The flexibility, efficiency, and performance of such systems has led users to shift from locally maintaining applications, services, and data to migrate to cloud computing platforms. Cloud computing environments have gained the interest of malicious entities, such as hackers who attempt to gain access to the computing resources of a user account in order to leverage the resources for their own malicious purposes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, devices, and computer readable storage media described herein provide techniques for identifying critical assets and prioritizing protective actions. In an aspect, configuration data associated with a first asset is received. An analysis result is generated based on an analysis of the configuration data. The first asset is determined to be a critical asset based on the analysis result. A prioritization action is performed based on the determination that the first asset is a critical asset. In a further aspect, a protective action is determined based on the analysis result. In another further aspect, a security vulnerability of the first asset is identified and resolved. In still another aspect, a protective action of the first asset is prioritized over a protective action of another asset.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for critical asset identification and protective action prioritization, in accordance with an example embodiment.

FIG. 2 shows a block diagram of a system for asset identification and prioritization action performance, in accordance with another example embodiment.

FIG. 3 shows a flowchart of a process for performing a prioritization action, in accordance with an example embodiment.

FIG. 4A shows a flowchart of a process for analyzing configuration data, in accordance with an example embodiment.

FIG. 4B shows a flowchart of a process for analyzing configuration data, in accordance with another example embodiment.

FIG. 4C shows a flowchart of a process for analyzing configuration data, in accordance with another example embodiment.

FIG. 5 shows a flowchart of a process for detecting a change in a computing environment, according to an example embodiment.

FIG. 6 shows a flowchart of a process for determining an asset is a critical asset, in accordance with an example embodiment.

FIG. 7 shows a flowchart of a process for determining an asset is a critical asset, in accordance with another example embodiment.

FIG. 8 shows a flowchart of a process for determining an asset is a critical asset, in accordance with another example embodiment.

FIG. 9 shows a flowchart of a process for determining an asset is a critical asset, in accordance with another example embodiment.

FIG. 10 shows a block diagram of a system for performing a prioritization action based on an attack path, in accordance with an example embodiment.

FIG. 11 shows a flowchart of a process for performing a prioritization action based on an attack path, in accordance with an example embodiment.

FIG. 12 shows a block diagram of a system for causing a protective action to be performed, in accordance with an example embodiment.

FIG. 13 shows a flowchart of a process for causing a protective action to be performed, in accordance with an example embodiment.

FIG. 14 shows a flowchart of a process for prioritizing a protective action, in accordance with an example embodiment.

FIG. 15 shows a flowchart of a process for displaying an identifier of an asset in a user interface, in accordance with an example embodiment.

FIG. 16 shows a flowchart of a process for recommending a protective action, in accordance with an example embodiment.

FIG. 17 shows a flowchart of a process for performing a protective action, in accordance with an example embodiment.

FIG. 18 shows an example of a user interface for displaying critical assets, in accordance with an example embodiment.

FIG. 19 shows a block diagram of a system for causing a remedial action to be performed, in accordance with an example embodiment.

FIG. 20 shows a flowchart of a process for causing a remedial action to be performed, in accordance with an example embodiment.

FIG. 21 shows a block diagram of system for identifying a critical asset, in accordance with an example embodiment.

FIG. 22 shows a block diagram of system for identifying a critical asset, in accordance with another example embodiment.

FIG. 23 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Asset Identification and Action Prioritization

Embodiments of the present disclosure relate to classification of assets in a cloud-based system. Cloud-based systems are utilized to host a computing environment for a user (e.g., a tenant or other type of user described herein). In this context, a computing environment comprises a combination of hardware, software, and/or network assets (also referred to as “resources” or “resources and services” in some embodiments) utilized to execute code, run applications, run workloads, store data, and/or perform other operations within the computing environment. Examples of assets include, but are not limited to, virtual machines, virtual machine scale sets, machine learning (ML) workspaces (e.g., a group of compute intensive virtual machines for training machine learning models and/or performing other graphics processing intensive tasks), serverless functions, storage disks, web applications, database servers, data objects (e.g., data file(s), table(s), structured data, unstructured data, etc.), a cluster (e.g., a cluster of nodes), and/or any other type of hardware, software, and/or network resource associated with a user's computing environment described elsewhere herein. As the cyber security world continues to evolve, and as customers shift workloads and assets into the cloud, service providers may incorporate techniques for providing insight and management capabilities to the users (e.g., in a cloud security posture management implementation).

Embodiments of the present disclosure provide techniques for identifying and/or performing operations with respect to critical assets within a user's (e.g., cloud) computing environment. A critical asset is an asset that is important to a user and/or the integrity of the user's computing environment and/or sensitive data (e.g., personally identifying information, secrets (e.g., passwords, passcodes, etc.), and/or the like). In accordance with an embodiment, a critical asset is an asset that has a level of importance higher than (some or all, e.g., above a predetermined threshold percentage thereof) other assets in a user's computing environment. By identifying critical assets, a service provider's system or a user is able to determine whether or not a critical asset should be further protected from cyber-attacks. For instance, some aspects described herein present (e.g. a list of) critical assets (and/or information related to the critical assets) in a user interface such that a user (or a system of the user) can determine whether or not to perform actions to further protect the critical assets.

In an aspect of the present disclosure, methods, systems, and computer readable storage medium described herein provide techniques for identifying critical assets in various ways. For example, in an example embodiment, configuration data associated with a first asset is received. In implementations, the configuration data comprises a configuration of the asset (e.g., a property of the asset, a component of the asset, hardware associated with the asset, software executable by (or assigned to, or downloaded to) the asset, authorizations of the asset, data stored by the asset, and/or the like), a configuration of other assets within the same computing environment as the asset, and/or a configuration of the computing environment the asset is located within (or otherwise associated with) (e.g., a setting applied to the computing environment (or a portion of the computing environment), rules of the computing environment, and/or the like. In embodiments, an analysis result is generated based on an analysis of the configuration data. In embodiments, an analysis result is the result of an application, service, or component analyzing configuration data. Examples of analysis results include, but are not limited to, a result of analyzing data included in the configuration data of an asset, a result of measuring a level of uniqueness between two assets, a result of analyzing a computer environment an asset is located in, and/or any other type of result of an analysis of configuration data described elsewhere herein. A determination of whether or not the asset is a critical asset is made based on the analysis result. Based on the determination, a prioritization action is performed. A prioritization action is an action performed with respect to a determined critical asset. In embodiments, prioritization actions are utilized to provide insight to a critical asset, implement security measures with respect to the critical asset, and/or otherwise manage the critical asset. Examples of prioritization actions include, but are not limited to, causing a user interface of a computing device to display an identifier of a critical asset (or other information associated with the critical asset), determining and/or causing protective actions to be performed with respect to a critical asset, prioritizing implementation of security measures with respect to a critical asset over those implemented with respect to another (e.g., non-critical or lower level of criticality) asset, and/or any other type of action to be performed based on determination that an asset is a critical asset, as described further herein. By determining criticality of assets and performing prioritization actions, embodiments describe herein improve operation of security systems that protect assets (e.g., by performing actions with respect to assets that are critical) and user interfaces that display information regarding a user's assets (e.g., by filtering out assets that are not critical in security measure recommendation systems, thereby reducing noise in determining which assets should have additional security measures applied to them).

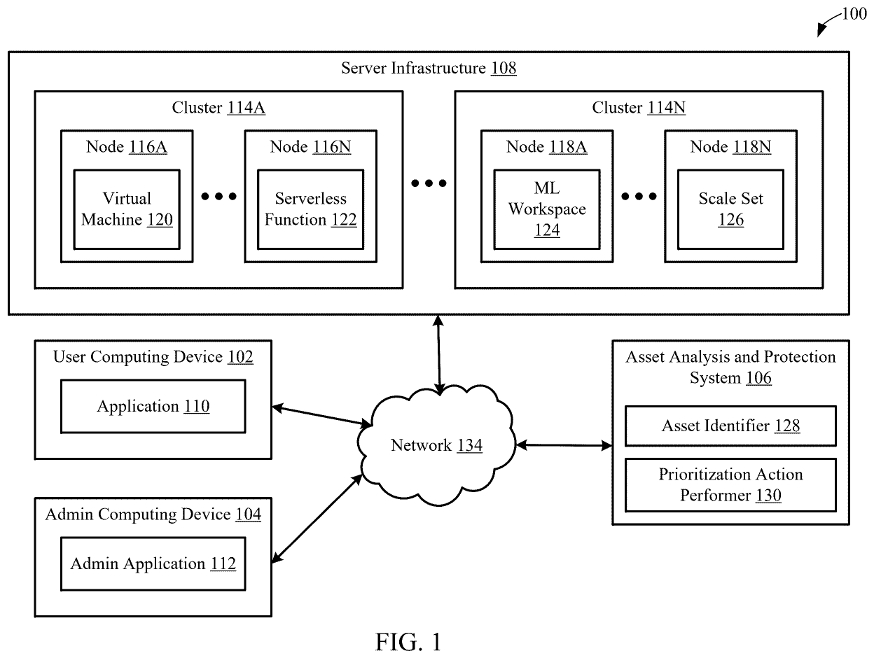

Systems, devices, and apparatuses may be configured in various ways for classifying assets. For example, FIG. 1 shows a block diagram of a system 100 for asset classification, in accordance with an example embodiment. System 100 comprises a user computing device 102, an admin computing device 104, an asset analysis and protection system 106, and a server structure 108, which are communicatively coupled via a network 134. In examples, network 134 comprises one or more networks such as local area networks (LANs), wide area networks (WANs), enterprise networks, the Internet, etc. In examples, network 134 comprises one or more wired and/or wireless portions. The features of system 100 are described in detail as follows.

Server infrastructure 108 is a network-accessible server set (e.g., a cloud-based environment or platform). As shown in FIG. 1, server infrastructure 108 includes one or more clusters 114A and 114N (collectively referred to as “clusters 114A-114N”). Each of clusters 114A-114N may comprise a group of one or more nodes (also referred to as compute nodes) and/or a group of one or more storage nodes. For example, as shown in FIG. 1, cluster 114A includes nodes 116A-116N and cluster 114N includes nodes 118A-118N. Each of nodes 116A-116N and/or 118A-118N are accessible via network 134 (e.g., in a “cloud-based” embodiment) to build, deploy, and manage assets. In some examples, any of nodes 116A-116N and/or 118A-118N comprises a storage node that comprises a physical storage disk (or a plurality of physical storage disks) that is accessible via network 134 and is configured to store data associated with the applications and services managed by nodes 116A-116N and/or 118A-118N.

In an embodiment, one or more of clusters 114A-114N are co-located (e.g., housed in one or more nearby buildings with associated components such as backup power supplies, redundant data communications, environmental controls, etc.) to form a datacenter. For instance, in a non-limiting example, clusters 114A-114N are located in a datacenter in a distributed collection of datacenters. In accordance with another embodiment, one or more of clusters 114A-114N are arranged in other manners.

In embodiments, each of node(s) 116A-116N and 118A-118N comprise one or more server computers, server systems, and/or computing devices. In embodiments, any (or all) of node(s) 116A-116N and 118A-118N are configured to host and/or otherwise manage one or more assets (e.g., software applications, services, hardware resources), which are utilized by users (e.g., of user computing device 102 and/or admin computing device 104) of the network-accessible server set. For example, as shown in FIG. 1, node 116A executes a virtual machine 120, node 116N executes a serverless function 122, node 118A executes a ML workspace 124, and node 118N executes a scale set 126. In some examples, an asset is distributed across multiple nodes. For instance, in an alternative embodiment, scale set 126 comprises multiple virtual machines distributed across different nodes of cluster 114N.

User computing device 102 and admin computing device 104 are each any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, user computing device 102 is associated with a user (e.g., an individual user, a group of users, an organization, a family user, a customer user, an employee user, a tenant, etc.). User computing device 102 is configured to execute an application 110. In accordance with an embodiment, application 110 enables a user to interface with server infrastructure 108 and/or asset analysis and protection system 106, e.g., to create assets, to manage assets, to remove assets, to utilize assets, to receive output from asset analysis and protection system 106, and/or the like.

In accordance with an embodiment, admin computing device 104 is associated with an admin user (e.g., an individual admin user (e.g., a developer, a system administrator, a service team user, a management user), a group of admin users, a service provider (and/or employees thereof), etc.). Admin computing device 104 is configured to execute an admin application 112. In accordance with an embodiment, admin application 112 enables an admin user to interface with user computing device 102, asset analysis and protection system 106, and/or server infrastructure 108, e.g., to configure and/or otherwise manage asset analysis and protection system 106, to manage server infrastructure 108, to transmit communication to and/or receive communication from user computing device 102, and/or the like.

Asset analysis and protection system 106 comprises one or more computing devices and is configured to analyze and perform actions with respect to assets of server infrastructure 108 (e.g., virtual machine 120, serverless function 122, ML workspace 124, scale set 126, etc.). As shown in FIG. 1, asset analysis and protection system 106 comprises an asset identifier 128 and a prioritization action performer 130. In accordance with an embodiment, asset identifier 128 and prioritization action performer 130 are implemented as services/applications executable by a processor of asset analysis and protection system 106 to perform operations. As shown in FIG. 1, asset analysis and protection system 106 is a separate sub-system of system 100. Alternatively, one or more components of asset analysis and protection system 106 are incorporated within user computing device 102, admin computing device 104, and/or server infrastructure 108. In accordance with an embodiment, asset analysis and protection system 106 performs operations with respect to (e.g., the entirety of) a service provider's offerings (e.g., all assets provided within a cloud computing environment of a cloud service provider of admin computing device 104 and server infrastructure 108). Alternatively, asset analysis and protection system 106 performs operations with respect to a subset of a service provider's offerings (e.g., a particular customer (e.g., a tenant), a group of customers, a region, a percentage of offerings, etc.).

In embodiments, asset identifier 128 is configured to analyze configuration data of a user's computing environment (and/or assets therein) and identify critical assets. In some implementations, configuration data for a user's computing environment (and/or its assets) is provided to asset identifier 128 (e.g., by the assets or by an asset manager of the computing environment). Alternatively, asset identifier 128 scans (or otherwise monitors) the computing environment for changes in the environment and/or to assets in the environment. For instance, as a non-limiting example, suppose serverless function 122, ML workspace 124, and scale set 126 are assets in a user computing environment of the user associated with user computing device 102 and virtual machine 120 has not been launched on node 116A yet. In this example, asset identifier 128 monitors serverless function 122, ML workspace 124, and scale set 126 for changes therein. Further suppose, in this example, a user interacts with application 110 to launch virtual machine 120 on node 116A of cluster 114A. In this context, asset identifier 128 scans node 116A, determines virtual machine 120 has been created on node 116A, and obtains configuration data for virtual machine 120. In any case, asset identifier 128 analyzes configuration data associated with assets of a user's environment and determines which assets are critical assets (if any) based on results of the analysis.

Prioritization action performer 130 is configured to perform a prioritization action with respect to a critical asset identified by asset identifier 128. As described herein, a prioritization action is an action performed with respect to a determined critical asset. Prioritization actions are utilized to provide insight to a critical asset, implement security measures with respect to the critical asset, and/or otherwise manage the critical asset. By performing prioritization actions based on an automatic determination of a critical asset, embodiments of prioritization action performer 130 (in conjunction with asset identifier 128) efficiently identify actions to be performed with respect to critical assets. In this manner, such embodiments improve the security of a user's computing environment (e.g., by automatically identifying an asset that should be protected to preserve integrity of a user's data and/or environment, by automatically performing an action to implement a security measure with respect to an identified asset, by alerting a user (or a user's system) of security vulnerabilities or of critical assets, and/or the like).

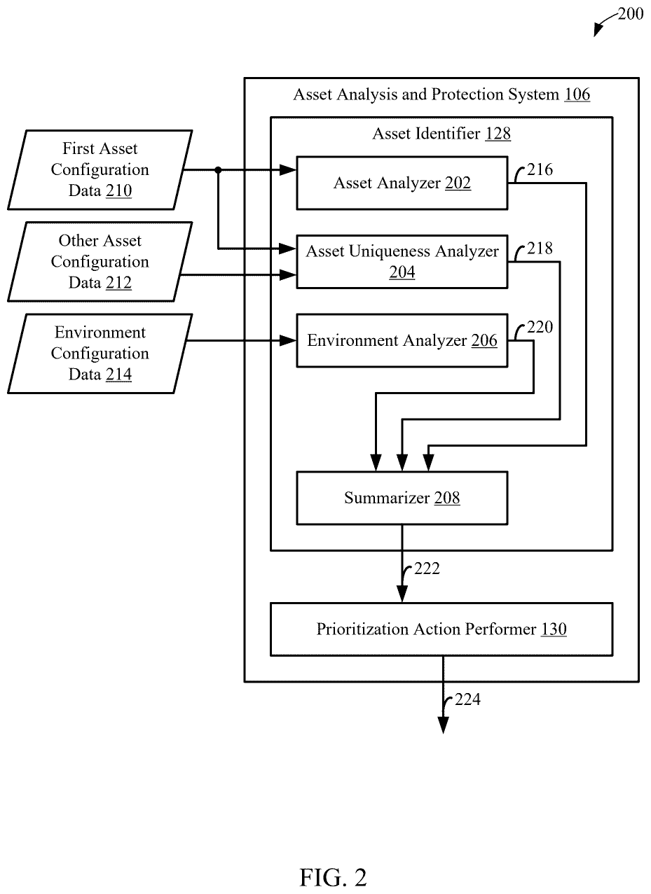

Embodiments of asset analysis and protection system 106 are configured in various ways to identify critical assets and perform prioritization actions. For instance, FIG. 2 shows a block diagram of a system 200 for asset identification and prioritization action performance, in accordance with another example embodiment. As shown in FIG. 2, system 200 comprises asset analysis and protection system 106 (comprising asset identifier 128 and prioritization action performer 130), as described with respect to FIG. 1, first asset configuration data 210, other asset configuration data 212, and environment configuration data 214. In accordance with an embodiment, first asset configuration data 210, other asset configuration data 212, and environment configuration data 214 are stored in a data storage (not shown in FIG. 2 for brevity). Examples of such a data storage include, but are not limited to, a storage node of server infrastructure 108, a storage component of a computing device (included in or external to server infrastructure 108), a dedicated storage device, and/or any other type of device suitable for storing data. In accordance with an embodiment, the data storage is a distributed data store (i.e., distributed across multiple storage devices). In accordance with another embodiment, some or all of first asset configuration data 210, other asset configuration data 212, and/or environment configuration data 214 are obtained (or otherwise received from) associated devices/applications. For instance, in accordance with an embodiment, first asset configuration data 210 is obtained by scanning a first asset of a user's computing environment, other asset configuration data 212 is obtained by scanning one or more additional assets of a user's computing environment, and environment configuration data 214 is obtained by scanning the user's computing environment and/or an asset managing device/component of the user's computing environment.

As also shown in FIG. 2, asset identifier 128 comprises an asset analyzer 202, an asset uniqueness analyzer 204, an environment analyzer 206, and a summarizer 206, each of which are implemented as subcomponents and/or subservices of asset identifier 128, in embodiments. In accordance with an embodiment, asset identifier 128 (or asset analysis and protection system 106) comprises additional components and/or services not shown in FIG. 2 for brevity. For instance, in accordance with an embodiment, asset identifier 128 comprises a computing environment scanner that scans a computing environment to receive configuration data associated with the computing environment and/or assets within the computing environment.

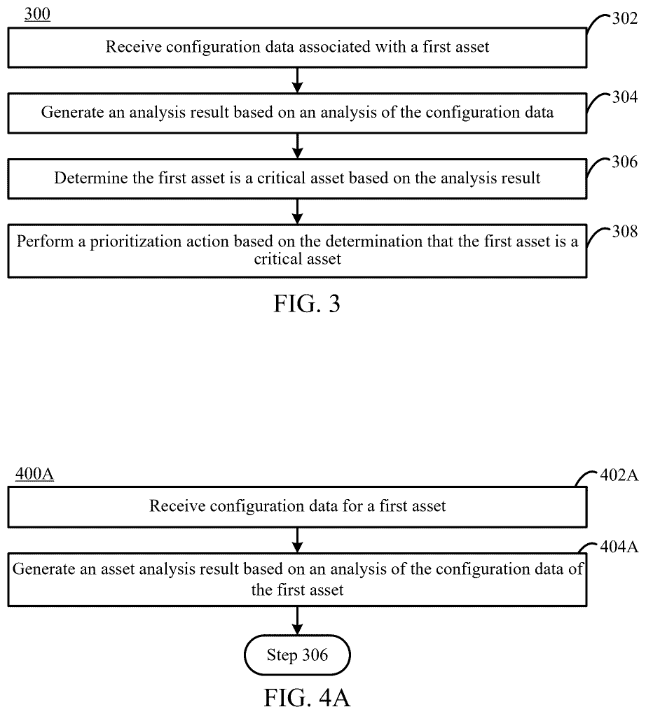

To better understand the operation of asset analysis and protection system 106, FIG. 2 is described with respect to FIG. 3. FIG. 3 shows a flowchart 300 of a process for performing a prioritization action, in accordance with an example embodiment. In an embodiment, asset analysis and protection system 106 operates according to the steps of flowchart 300. Note not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, configuration data associated with a first asset is received. In accordance with an embodiment, asset identifier 128 comprises an analyzer component (not shown in FIG. 2) that receives (e.g., any/all) configuration data). Alternatively, as shown in FIG. 2, asset identifier 128 comprises asset analyzer 202, which receives first asset configuration data 210, asset uniqueness analyzer 204, which receives first asset configuration data 210 and other asset configuration data 212, and environment analyzer 206, which receives environment configuration data 214. First asset configuration data 210 comprises data regarding a configuration a first asset, Asset A, other asset configuration data 212 comprises data regarding a configuration of one or more assets, Assets B-n, and environment configuration data 214 comprises data regarding a configuration of a computing environment, Environment E. In examples, Asset A and Assets B-n are part of Environment E. In accordance with an embodiment, Environment E is a computing environment of a user (e.g., a tenant). In some embodiments, asset identifier 128 (or its components) receive first asset configuration data 210 from Asset A or from an asset manager of Environment E, receive other asset configuration data 212 from respective Assets B-n or the asset manager of Environment E, and receive environment configuration data 214 from the asset manager of Environment E. Alternatively, asset identifier 128 (or its components) scan assets of Environment E to obtain first asset configuration data 210, other asset configuration data 212, and/or environment configuration data 214.

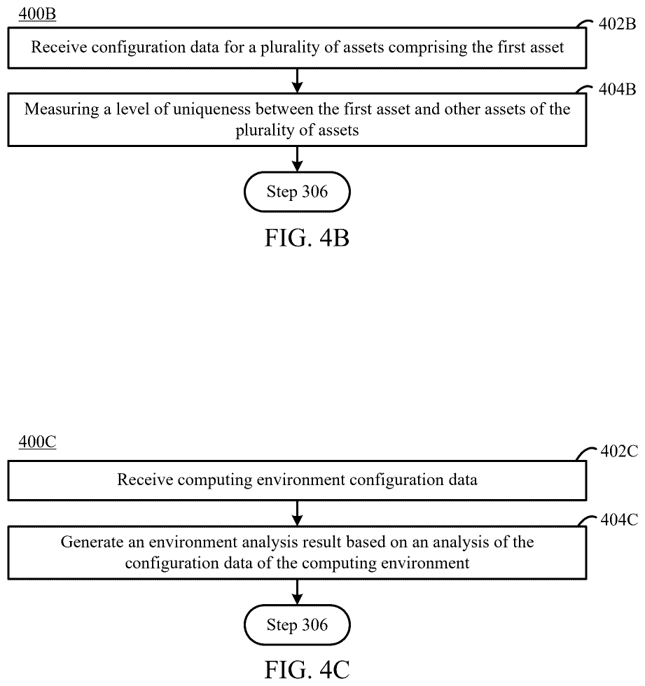

In step 304, an analysis result is generated based on an analysis of the configuration data. For example, asset identifier 128 of FIG. 2 (or a component thereof) analyzes configuration data received in step 302 to generate an analysis result. For instance, as shown in FIG. 2, asset analyzer 202 generates an asset analysis result 216 based on an analysis of first asset configuration data 210, asset uniqueness analyzer 204 generates a uniqueness analysis result 218 based on an analysis of first asset configuration data 210 and other asset configuration data 212, and environment analyzer 206 generates an environment analysis result 220 based on an analysis of environment configuration data 214. Each of asset analyzer 202, asset uniqueness analyzer 204, environment analyzer 206, and/or any other type of analyzer of asset identifier 128 (not shown in FIG. 2 for brevity) operates to analyze received configuration data in various ways. For instance, such analyzers may compare data between assets, compare data between an asset and its environment, identify keywords in configuration data, identify configuration options and/or properties that are associated with key phrases, and/or otherwise analyze configuration data to generate analysis results. Additional details regarding operation of asset analyzer 202, asset uniqueness analyzer 204, and environment analyzer 206 are described with respect to FIGS. 4A-4C, as well as elsewhere herein.

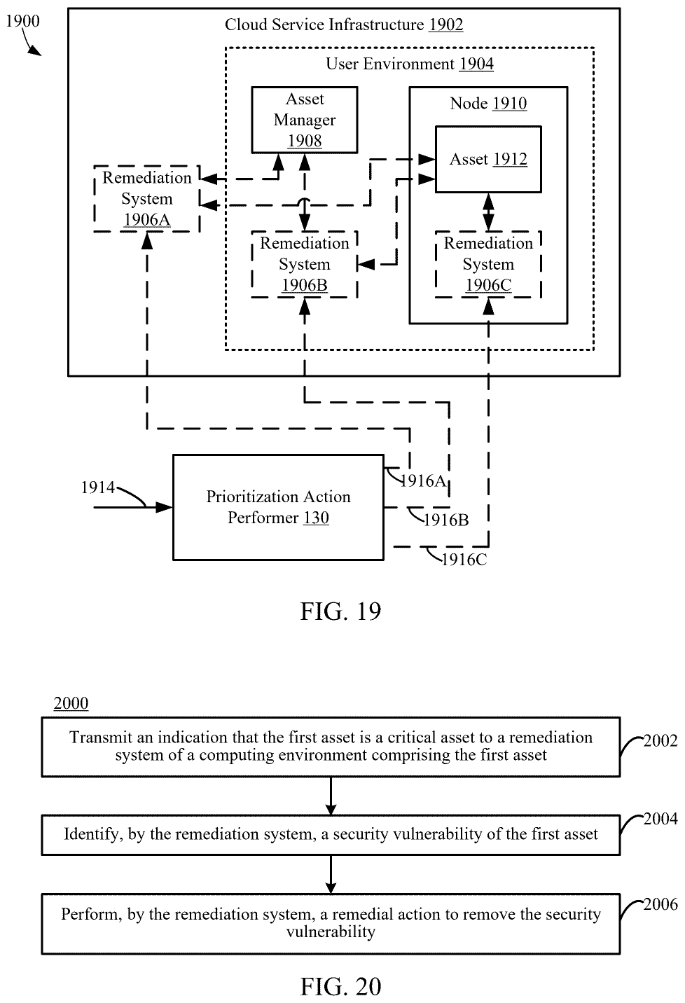

In step 306, the first asset is determined to be a critical asset based on the analysis result. For example, summarizer 206 of FIG. 2 determines Asset A is a critical asset based on the analysis result generated in step 304. For instance, in accordance with an embodiment, summarizer 208 determines Asset A is a critical asset based on asset analysis result 216, uniqueness analysis result 218, and/or environment analyzer 220. In this context, summarizer 206 infers Asset A is a critical asset based on analysis of configuration data associated with Asset A. In this manner, summarizer 206 reduces the time a user (or an application operating on behalf of the user) would spend manually reviewing each asset of a computing environment (which may include many assets with many different configurations) to determine if that particular asset is critical or not. Furthermore, as discussed elsewhere herein (and particularly with respect to FIGS. 19 and 20), by automatically identifying critical assets, summarizer 206 improves operation of systems that identify security vulnerabilities of assets.

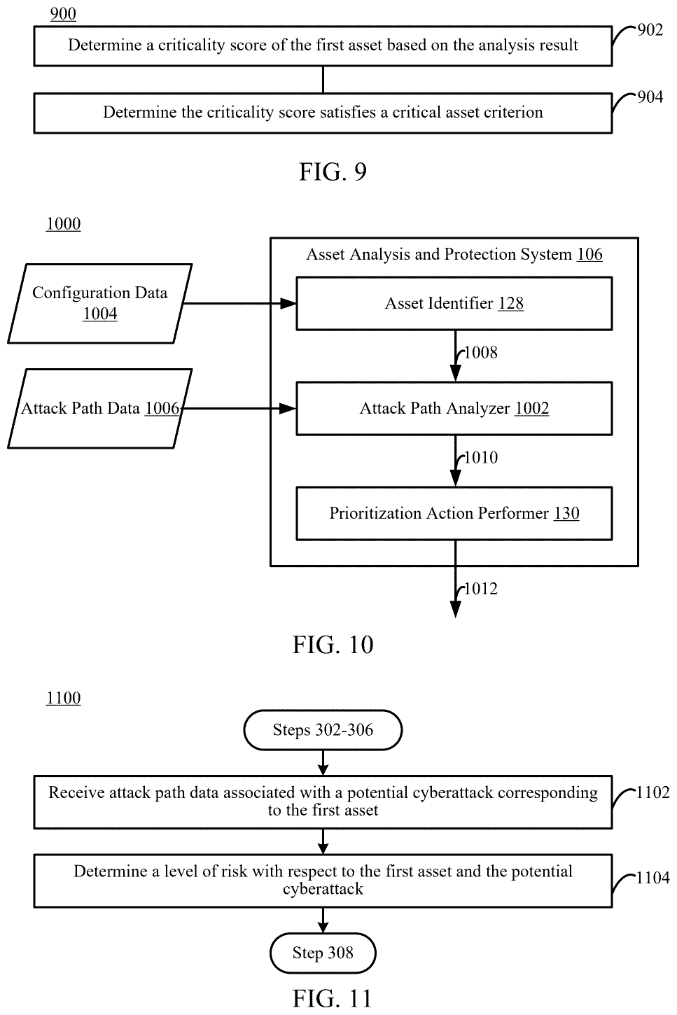

Implementations of summarizer 208 operate in various ways to determine Asset A is a critical asset, including, but not limited to, determining if an analysis result satisfies a rule for determining an asset is a critical asset, basing the determination on properties or other characteristics identified in asset analysis result 216 (e.g., determining a number of properties or other characteristics satisfies an asset criticality criterion, determining a particular property or characteristic satisfies the asset criticality criterion, and/or the like), determining a level of uniqueness in uniqueness analysis result 218 satisfies a uniqueness criterion (e.g., as described further with respect to FIG. 6), determining an environment characteristic identified in environment analysis result 220 satisfies an environment criticality criterion (e.g., based on an asset lock identified in environment analysis result 220 (e.g., as described further with respect to FIG. 7), based on an immutable storage protocol identified in environment analysis result 220 (e.g., as described further with respect to FIG. 8), and/or the like), determining based on a combination of analysis results, determining based on a single analysis result, calculating a criticality score based on one or more analysis results (e.g., as described further with respect to FIG. 9), and/or any other manner for determining an asset is a critical asset, as described elsewhere herein.

As shown in FIG. 2, summarizer 208 provides criticality indication signal 222 to prioritization action performer 130. Criticality indication signal 222 indicates Asset A is a critical asset. In accordance with an embodiment, criticality indication signal 222 indicates a level importance of Asset A to the security of the computing environment and/or data accessible thereto (or stored thereby). In accordance with another embodiment, criticality indication signal 222 indicates a likelihood Asset A would be targeted by a cyber-attack (e.g., a virtual machine with access to secrets and/or expensive hardware components, may be more likely to be targeted in a cyber-attack than a regular virtual machine without access to secrets). Depending on the implementation, summarizer 208 provides a separate criticality indication signal for each asset determined to be a critical asset or for multiple assets determined to be critical assets. For instance, in accordance with an embodiment, suppose asset identifier 128 operates to identify critical assets for (e.g., the entirety of or a portion of) a computing environment of a user. In this context, summarizer 208 generates a separate criticality indication signal for each asset determined to be a critical asset or a single criticality indication signal (e.g., criticality indication signal 222) indicating (e.g., all of) the asset(s) determined to be critical for that computing environment.

In some embodiments, summarizer 208 operates in a manner that determines Asset A is a critical asset based on a single analysis result or a subset of (e.g., all) analysis results. For instance, suppose summarizer 208 receives analysis results from asset analyzer 202, asset uniqueness analyzer 204, and environment analyzer 206 at different times. In a non-limiting example, further suppose summarizer 208 determines Asset A is a critical asset based on the first analysis result received (e.g., asset analysis result 216). In this alternative, summarizer 208 provides criticality indication signal 222 indicating Asset A as a critical asset based on the first analysis result (e.g., without considering and/or receiving other analysis results (e.g., later received analysis results)). In this context, summarizer 208 is able to notify prioritization action perform 130 of critical assets with reduced use in compute resources or in a manner that quickly identifies critical assets. In some embodiments, summarizer 208 further reduces compute resources by causing further analysis with respect to Asset A by asset analyzer 202, asset uniqueness analyzer 204, and/or environment analyzer 206 to cease. Alternatively, summarizer 208 updates rationale for Asset A's criticality as additional asset results are generated and considered.

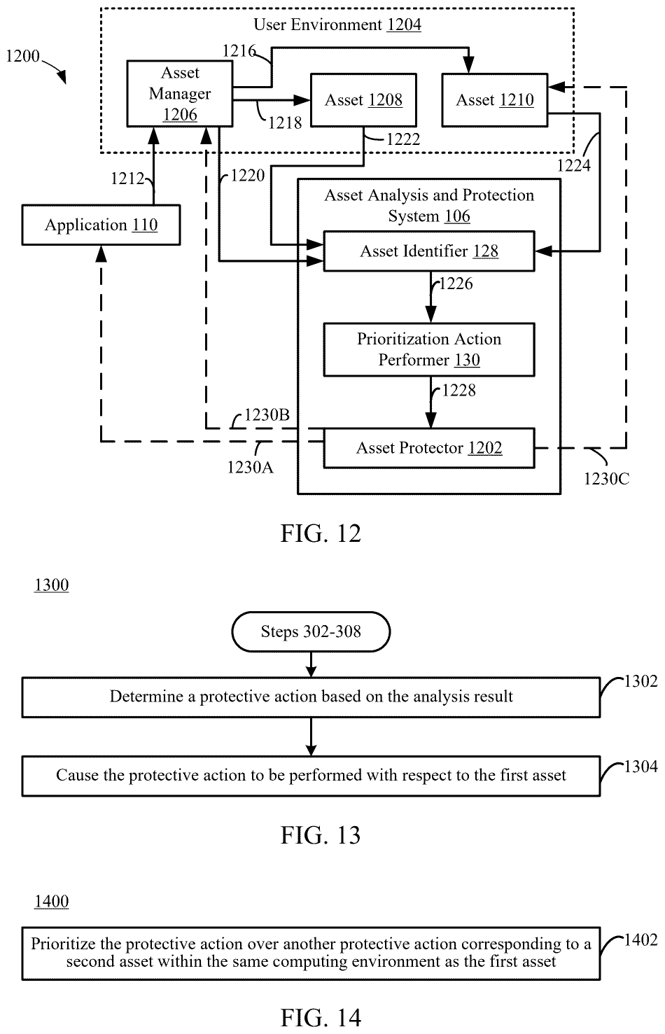

In step 308, a prioritization action is performed based on the determination that the first asset is a critical asset. For example, prioritization action performer 130 of FIG. 2 performs a prioritization action 224 based on the determination that Asset A is a critical asset. For instance, in an embodiment, prioritization action performer 130 performs prioritization action 224 in response to receiving criticality indication signal 222. Depending on the implementation, prioritization action performer 130 performs prioritization action 224 by transmitting information to be displayed in a user interface (e.g., of user computing device 102 and/or admin computing device 104), causing an action to be performed by a critical asset, a managing service of the critical asset, or a managing device of the critical asset, and/or providing information to another component of asset analysis and protection system 106 (not shown in FIG. 2) for further processing (e.g., as further described with respect to FIGS. 12-14, and elsewhere herein).

Embodiments of asset identifier 128 analyze configuration data in various ways. For instance, asset identifier 128 comprising asset analyzer 202 analyze asset configuration data of an asset, asset identifier 128 comprising asset uniqueness analyzer 204 analyze asset configuration data of multiple assets, and asset identifier 128 comprising environment analyzer 206 analyze environment configuration data. Such embodiments operate in various ways. To better understand the operation of asset identifier 128 comprising asset analyzer 202, FIG. 2 is described with respect to FIG. 4A. For example, FIG. 4A shows a flowchart 400A of a process for analyzing configuration data, in accordance with an example embodiment. In an embodiment, asset analyzer 202 of FIG. 2 operates according to the steps of flowchart 400A. Note not all steps of flowchart 400A need be performed in all embodiments. Further structural and operational embodiments will be apparent to persons skilled in the relevant art(s) based on the following description of FIG. 4A with respect to FIG. 2.

Flowchart 400A begins with step 402A, which is a further example of step 302 of flowchart 300 of FIG. 3. In step 402A, configuration data for a first asset is received. For example, with respect to FIG. 2, asset analyzer 202 receives first asset configuration data 210. As described with respect to step 302 of FIG. 3, asset analyzer 202 receives configuration data in various ways (e.g., receiving from assets, receiving from an asset manager, via scanning or otherwise obtaining configuration data, and/or the like). In accordance with an embodiment, asset analyzer 202 obtains configuration data from a data storage (not shown in FIG. 2 for brevity).

Flowchart 400A proceeds to step 404A, which is a further example of step 304 of flowchart 300 of FIG. 3. In step 404A, an asset analysis result is generated based on an analysis of the configuration data for the first asset. For example, asset analyzer 202 generates asset analysis result based on an analysis of first asset configuration data 210. In embodiments, asset analyzer 202 analyzes first asset configuration data 210 to determine the type of asset, configurations and properties of the asset (e.g., hardware components of the asset (e.g., inclusion of a graphics processing unit, inclusion of a neural processing unit, etc.), a size of a storage space of the asset (e.g., a premium storage space configuration), a type of processor of the asset, a network bandwidth capability of the asset, a security configuration of the asset (e.g., private storage access only, public storage access, a confidential virtual machine configuration, etc.), and/or any other configuration and/or property of hardware and/or software of the asset), type of data associated with (e.g., stored by) the asset, and/or any other information associated with the configuration and/or operation of the asset. Subsequent to step 404A, flowchart 400A proceeds to step 306, as described with respect to flowchart 300 of FIG. 3.

Embodiments of asset identifier 128 comprising asset uniqueness analyzer 204 operate in various ways. For example, FIG. 4B shows a flowchart 400B of a process for analyzing configuration data, in accordance with an example embodiment. In an embodiment, asset uniqueness analyzer 204 operates according to the steps of flowchart 400B. Note not all steps of flowchart 400B need be performed in all embodiments. Further structural and operational embodiments will be apparent to persons skilled in the relevant art(s) based on the following description of FIG. 4B with respect to FIG. 2.

Flowchart 400B starts with step 402B, which is a further example of step 302 of flowchart 300 of FIG. 3. In step 402B, configuration data for a plurality of assets are received, the plurality of assets comprising the first asset. For example, with respect to FIG. 2, asset uniqueness analyzer 204 receives first asset configuration data 210 and other asset configuration data 212. As described with respect to step 302 of FIG. 3, asset uniqueness analyzer 204 receives configuration data in various ways (e.g., receiving from assets, receiving from an asset manager, via scanning or otherwise obtaining configuration data, and/or the like). In accordance with an embodiment, asset uniqueness analyzer 204 obtains configuration data from a data storage (not shown in FIG. 2 for brevity).

Flowchart 400B proceeds to step 404B, which is a further example of step 304 of flowchart 300 of FIG. 3. In step 404B, a level of uniqueness between the first asset and other assets of the plurality of assets is measured. For example, asset uniqueness analyzer 204 measures a level of uniqueness between Asset A and Assets B-n. In accordance with an embodiment, uniqueness analysis result 218 comprises the measured level of uniqueness. In accordance with an embodiment, asset uniqueness analyzer 204 measures the level of uniqueness by comparing first asset configuration data 210 to other asset configuration data 212. In accordance with another embodiment, asset uniqueness analyzer 204 measures the level of uniqueness by comparing first asset configuration data 210 to average properties/configurations of first asset configuration data 210 and other asset configuration data 212. In accordance with another embodiment, asset uniqueness analyzer 204 analyzes configuration data of (e.g., all) assets (e.g., including first asset configuration data 210 and other asset configuration data 212) and determines which assets have a level of uniqueness higher than a threshold (or otherwise satisfy a uniqueness criterion). Subsequent to step 404B, flowchart 400B proceeds to step 306, as described with respect to flowchart 300 of FIG. 3.

Asset uniqueness analyzer 204 determines uniqueness based on various factors. For instance, asset uniqueness analyzer 204 determines the first asset is different from other assets in the plurality of assets based on hardware it is equipped with that a majority of other assets (of the same type, of other types, etc.) are not equipped with (e.g., a high-end GPU), whether or not the asset is in a virtual network (VNET) separate from (e.g., some or all) other assets, the geographic location of the asset being different from other assets, a fault tolerance or reliability configuration compared to other assets, the monetary cost to utilize a particular asset, and/or any other factor that may be analyzed to determine a level of uniqueness between the first asset and other assets in a computing environment. For instance, as a non-limiting example, suppose a computing environment comprises multiple storage accounts wherein most of the storage accounts have public access enables but one storage account has only private access enabled. In this context, asset uniqueness analyzer 204 generates a uniqueness analysis result indicating the storage account with private access restrictions enabled is unique relative to other storage accounts of the computing environment (e.g., and protection of this storage account should be prioritized over protection of the other storage accounts).

Embodiments of asset identifier 128 comprising environment analyzer 206 operate in various ways. For example, FIG. 4C shows a flowchart 400C of a process for analyzing configuration data, in accordance with an example embodiment. In an embodiment, environment analyzer 206 operates according to the steps of flowchart 400C. Note not all steps of flowchart 400C need be performed in all embodiments. Further structural and operational embodiments will be apparent to persons skilled in the relevant art(s) based on the following description of FIG. 4C with respect to FIG. 2.

Flowchart 400C begins with step 402C, which is a further example of step 302 of flowchart 300 of FIG. 3. In step 402C, configuration data for a computing environment is received, the computing environment comprising the first asset. For example, with respect to FIG. 2, environment analyzer 206 receives environment configuration data 214. As described with respect to step 302 of FIG. 3, asset analyzer 202, asset uniqueness analyzer 204, and environment analyzer 206 receive respective configuration data in various ways (e.g., receiving from assets, receiving from an asset manager, via scanning or otherwise obtaining configuration data, and/or the like). In accordance with an embodiment, asset analyzer 202, asset uniqueness analyzer 204, and/or environment analyzer 206 obtain configuration data from a data storage (not shown in FIG. 2 for brevity).

Flowchart 400C proceeds to step 404C, which is a further example of step 304 of flowchart 300 of FIG. 3. In step 404C, an environment analysis result is generated based on an analysis of the configuration data for the computing environment. For example, environment analyzer 206 generates environment analysis result 220 based on an analysis of environment configuration data 214. In embodiments, environment analyzer 206 analyzes environment configuration data 214 to determine if an asset lock is applied to the asset or a group of assets comprising the asset, to determine if the asset is subject to an immutable storage protocol, and/or any other information associated with the configuration and/or operation of the computing environment comprising the asset. Subsequent to step 404C, flowchart 400C proceeds to step 306, as described with respect to flowchart 300 of FIG. 3.

As shown in FIGS. 4A-4C, subsequent to steps 404A, 404B, and/or 404C, flow proceeds to step 306, as described with respect to flowchart 300 of FIG. 3. In embodiments, the first asset is determined to be a critical asset based on the asset analysis result, the level of uniqueness, and/or the environment analysis result. In some embodiments, the first asset is determined to be a critical asset based on multiple analysis results. For instance, as a non-limiting example, a virtual machine is determined to be a critical asset based on an asset analysis result indicating the virtual machine is a confidential virtual machine and an environment analysis result indicating an asset lock is applied to the virtual machine.

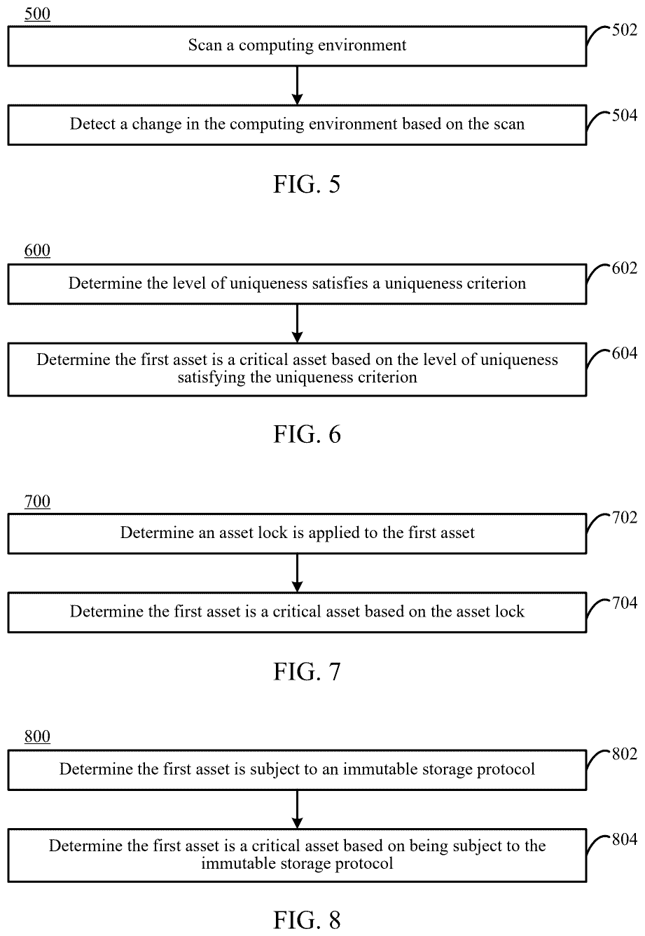

Asset identifier 128 operates to receive configuration data (e.g., first asset configuration data 210, other asset configuration data 212, environment configuration data 214, and/or the like) in various ways. For instance, in accordance with an embodiment, asset identifier 128 (or a component thereof) scans assets (or managing services/components) of a computing environment to determine changes in configurations of assets. In implementations, asset identifier 128 operates in various ways to detect changes. For example, FIG. 5 shows a flowchart 500 of a process for detecting a change in a computing environment. In an embodiment, asset identifier 128 operates according to the steps of flowchart 500. In accordance with an embodiment, flowchart 500 is a further embodiment of step 302 of flowchart 300 of FIG. 3. Note not all steps of flowchart 500 need be performed in all embodiments. Further structural and operational embodiments will be apparent to persons skilled in the relevant art(s) based on the following description of FIG. 5 with respect to FIG. 2.

Flowchart 500 begins with step 502. In step 502, a computing environment is scanned. For example, asset identifier 128 of FIG. 2 (or a component thereof) scans Environment E. In accordance with an embodiment, asset identifier 128 scans Environment E by polling components of the environment (e.g., assets and/or asset managers) for configuration data. In accordance with another embodiment, asset identifier 128 scans Environment E for a timestamp since the last change in a configuration of Environment E or one or more assets thereof. In some embodiments, asset identifier 128 scans Environment E on a periodic basis (e.g., every ten minutes, every thirty minutes, every hour, at a fixed time in a day, and/or the like). In accordance with an alternative embodiment, asset identifier 128 receives a log generated by a usage logging service of Environment E (e.g., the log for a user session with an asset of Environment E, a maintenance log for Environment E, and/or the like) and scans the log. By scanning logs generated for Environment E, asset identifier 128 can passively detect updates to Environment E, which can reduce resources expended by asset identifier 128 and reduce network traffic between asset identifier 128 and components of Environment E.

In step 504, a change in the computing environment is detected based on the scan. For example, asset identifier 128 of FIG. 2 (or a component thereof) detects a change in Environment E based on scanning in step 502. In accordance with an embodiment, the change is detected based on a comparison of data included in the scan and data regarding previous configurations of Environment E. In accordance with another embodiment, the change is detected based on a change in a timestamp since the last change in the configuration of Environment E and a previous scan performed by asset identifier 128.

Asset identifier 128 operates in various ways to determine an asset is a critical asset, in embodiments. For instance, FIG. 6 shows a flowchart of a process for determining an asset is a critical asset, in accordance with an example embodiment. In an embodiment, asset identifier 128 operates according to the steps of flowchart 600. Flowchart 600 is a further example of step 306 of flowchart 300 of FIG. 3, in an embodiment. Note not all steps of flowchart 600 need be performed in all embodiments. Further structural and operational embodiments will be apparent to persons skilled in the relevant art(s) based on the following description of FIG. 6 with respect to FIG. 2.

Flowchart 600 begins with step 602. In step 602, the level of uniqueness is determined to satisfy a uniqueness criterion. For example, summarizer 208 of FIG. 2 determines the level of uniqueness of Asset A indicated by uniqueness analysis result 2218 satisfies a uniqueness criterion.

In step 604, the first asset is determined to be a critical asset based on the level of uniqueness satisfying the uniqueness criterion. For example, summarizer 208 determines Asset A is a critical asset based on the level of uniqueness of Asset A satisfying the uniqueness criterion.

As stated above, asset identifier 128 operates in various ways to determine an asset is a critical asset, in embodiments. For instance, FIG. 7 shows a flowchart 700 of a process for determining an asset is a critical asset, in accordance with another example embodiment. In an embodiment, asset identifier 128 operates according to the steps of flowchart 700. Note not all steps of flowchart 700 need be performed in all embodiments. Further structural and operational embodiments will be apparent to persons skilled in the relevant art(s) based on the following description of FIG. 7 with respect to FIG. 2.

Flowchart 700 begins with step 702. In accordance with an embodiment, step 702 is a further example of step 304 of flowchart 300 of FIG. 3. In step 702, an asset lock is determined to be applied to the first asset. For example, environment analyzer 206 determines an asset lock is applied to the first asset (e.g., Asset A) based on environment configuration data 214. An asset lock locks the scope of the asset to which it is applied to. For instance, as a non-limiting example, if an asset lock is applied to a group of assets, other entities (e.g., users, applications acting on behalf of a user, devices acting on behalf of a user, etc.) are unable to delete (or, in some implementations, otherwise modify) assets within the group unless the entity has permission to do so. In this context, by analyzing environment configuration data 214 and determining an asset lock is applied to an asset (or a container the asset is within), environment analyzer 206 identifies a potential critical asset (e.g., that should have a protection mechanism applied thereto).

Flowchart 700 continues to step 704, which, in accordance with an embodiment, is a further example of step 306 of flowchart 300 of FIG. 3. In step 704, the first asset is determined to be a critical asset based on the asset lock. For example, summarizer 208 determines Asset A is a critical asset based on the asset lock identified in step 704 (e.g. and indicated in environment analysis result 220).

As stated above, asset identifier 128 operates in various ways to determine an asset is a critical asset, in embodiments. For instance, FIG. 8 shows a flowchart 800 of a process for determining an asset is a critical asset, in accordance with another example embodiment. In an embodiment, asset identifier 128 operates according to the steps of flowchart 800. Note not all steps of flowchart 800 need be performed in all embodiments. Further structural and operational embodiments will be apparent to persons skilled in the relevant art(s) based on the following description of FIG. 8 with respect to FIG. 2.

Flowchart 800 begins with step 802. In accordance with an embodiment, step 802 is a further example of step 304 of flowchart 300 of FIG. 3. In step 804, the first asset is determined to be subject to an immutable storage protocol. For example, environment analyzer 206 analyzes environment configuration data 214 and determines Asset A is subject to an immutable storage protocol. An immutable storage protocol is a type of storage protocol that stores data in a write once, read many (WORM) state (i.e., once data is written it becomes non-erasable and non-modifiable (e.g., and is retained for a predetermined period of time)). In this context, by analyzing environment configuration data 214 and determining the asset is subject to an immutable storage protocol, environment analyzer 206 identifies a potential critical asset (e.g., that should have a protection mechanism applied thereto).

Flowchart 800 continues to step 804, which, in accordance with an embodiment, is a further example of step 306 of flowchart 300 of FIG. 3. In step 804, the first asset is determined to be a critical asset based on being subject to the immutable storage protocol. For example, summarizer 208 determines Asset A is a critical asset based on Asset A being subject to the immutable storage protocol determined in step 802 (e.g. and indicated in environment analysis result 220).

Thus, several examples of asset identifier 128 operating to determine an asset is a critical asset have been described with respect to FIGS. 6-8. In some embodiments, summarizer 206 determines an asset is a critical asset based on multiple factors. For instance, as a non-limiting example described with respect to FIGS. 2, 6, and 8, suppose asset uniqueness analyzer 204 measures a level of uniqueness of Asset A with respect to Assets B-n and summarizer 206 determines the level of uniqueness satisfies a uniqueness criterion (e.g., as described with respect to step 602 of flowchart 600 of FIG. 6). Further suppose environment analyzer 206 determines Asset A is subject to an immutable storage protocol (e.g., as described with respect to step 802 of flowchart 800 of FIG. 8). In this non-limiting example, summarizer 206 determines Asset A is a critical asset based on the level of uniqueness and it being subject to the immutable storage protocol.

In some embodiments, summarizer 206 determines an asset is a critical asset based on a criticality score. A criticality score indicates a likelihood that an asset is a critical asset (e.g., with respect to other assets, with respect to criteria in which a service provider or user defines a critical asset, and/or the like). Summarizer 206 operates in various ways to determine an asset is a critical asset based on a criticality score, in embodiments. For instance, FIG. 9 shows a flowchart 900 of a process for determining an asset is a critical asset, in accordance with another example embodiment. In an embodiment, asset identifier 128 operates according to the steps of flowchart 900. Note not all steps of flowchart 900 need be performed in all embodiments. Further structural and operational embodiments will be apparent to persons skilled in the relevant art(s) based on the following description of FIG. 9 with respect to FIG. 2.

Flowchart 900 begins with step 902. In step 902, a criticality score of the first asset is determined based on the analysis result. For example, summarizer 208 of FIG. 2 determines a criticality score of the first asset, Asset A, based on asset analyzer 216, uniqueness analysis result 218, and/or environment analysis result 220. In accordance with an embodiment, summarizer 208 determines a criticality on a score (e.g., 0 to 1, 1 to 100, and/or the like). In accordance with an embodiment a higher score indicates an asset is more critical than an asset with a lower score. Alternatively, a lower score indicates an asset is more critical than an asset with a higher score. In embodiments wherein multiple factors and/or analysis results contribute to a criticality score of an asset, different weights can be applied to different factors. For instance, as a non-limiting example, whether or not a virtual machine is a confidential virtual machine has a higher weight in determining a criticality score than whether the virtual machine is part of a scale set.

In step 904, the criticality score is determined to satisfy a critical asset criterion. For example, summarizer 208 of FIG. 2 determines the criticality score determined in step 902 is determined to satisfy a critical asset criterion. For instance, in a non-limiting example, the critical asset criterion specifies a threshold that an asset with a critical asset with a criticality score above (or, alternatively, below) is determined to be a critical asset. Alternatively, summarizer 208 assigns a criticality label to the asset (e.g., a “high criticality” label to assets with a criticality score within a first range indicating the asset is most likely a critical asset, a “moderate criticality” label to assets with a criticality score within a second range indicating the asset is less likely to be a critical asset than those with the “high criticality” label, and a “low criticality” label to assets with a criticality score within a third range indicating the asset is least likely to be a critical asset).

Thus, an example embodiment of determining a criticality score for an asset has been described with respect to FIGS. 2 and 9. In some implementations, criticality scores are determined based on multiple factors, thereby enabling consideration of multiple factors at a time in determining whether or not an asset is a critical asset. Furthermore, in an implementation, weights are applied to factors based on the likelihood the factor corresponds to a high level of criticality, thereby enabling summarizer 208 (or an admin user of summarizer 208) to toggle a level of impact the factor has in determining the overall criticality score of the asset. In this context, the effectiveness of the security system in determining a critical asset is improved, as factors more likely to correspond to an asset's criticality are weighted more than those less likely to correspond to the asset's criticality. In accordance with an embodiment, weights are applied by an admin user of summarizer 208 (e.g., interacting with admin application 112). In accordance with another embodiment, weights are determined by training summarizer 208 (e.g., utilizing a supervised or semi-supervised machine learning training method) to identify critical assets. In an embodiment, assets are prioritized with respect to one another based on the scores (e.g., an asset with a higher criticality score is prioritized over an asset with a lower criticality score). In accordance with an embodiment, assets are presented in a user interface (or flagged in the user interface) if their criticality score satisfies a critical asset criterion. In this context, the user interface is improved as visual clutter is reduced by prioritizing assets that are deemed critical (and, in some embodiments, de-prioritizing assets that are not deemed critical).

Further still, while some example embodiments of summarizer 208 of FIG. 2 have been described with respect to determining criticality scores based on multiple factors, embodiments described herein are not so limited. For example, in an alternative embodiment, summarizer 208 determines a criticality score based on a single factor of the analysis result generated in step 304 of flowchart 300 of FIG. 3 or a subset of factors. For instance, suppose summarizer 208 determines a subset of factors or a single factor indicates the first asset is a critical asset. In this context, summarizer 208 assigns a criticality score to the first asset based on the single factor or the subset of factors, as opposed to assigning a criticality score based on many (e.g., all) factors analyzed. By assigning a criticality score based on a subset of factors or a factor, summarizer 208 identifies critical assets in a manner that utilizes fewer resources (as not all analysis steps need be performed or not all results need be analyzed) and reduces time taken to identify a critical asset (which allows prioritization action forms to be performed quickly, thereby improving safety).

### III. Attack Path Analysis Embodiments

Embodiments of asset analysis and protection system 106 are configured in various manners to perform a prioritization action. For instance, FIG. 10 shows a block diagram of a system 1000 for performing a prioritization action based on an attack path, in accordance with an example embodiment. As shown in FIG. 10, system 1000 comprises asset analysis and protection system 106, as described with respect to FIG. 1, configuration data 1004, and attack path data 1006. Configuration data 1004 is a further example of first asset configuration data 210, other asset configuration data 212, and/or environment configuration data 214, in an embodiment. Attack path data 1006 comprises data regarding security vulnerabilities and cyber-attacks. In accordance with an embodiment, attack path data 1006 comprises historical cyber-attack data, common security risk data, paths in which a malicious entity (e.g., a hacker) may attempt to access an asset (also referred to as an “attack path” herein), and/or any other data associated with security risks and attack paths. In accordance with an embodiment, attack path data 1006 is stored in a data storage, not shown in FIG. 10 for brevity.

As shown in FIG. 10, asset analysis and protection system 106 comprises asset identifier 128 and prioritization action performer 130 (as described with respect to FIG. 1), as well as an attack path analyzer 1002. In order to better understand the operation of asset analysis and protection system 106 comprising attack path analyzer 1002, FIG. 10 is described with respect to FIG. 11. FIG. 11 shows a flowchart 1100 of a process for performing a prioritization action based on an attack path, in accordance with an example embodiment. In an embodiment, asset analysis and protection system 106 of FIG. 10 operates according to the steps of flowchart 1100. Note not all steps of flowchart 1100 need be performed in all embodiments. Further structural and operational embodiments will be apparent to persons skilled in the relevant art(s) based on the following descriptions of FIGS. 10 and 11.

Flowchart 1100 begins with steps 302-306, as described with respect to flowchart 300 of FIG. 3. For example, asset identifier 128 receives configuration data 1004 (e.g., in a similar manner as described with respect to step 302), analyzes configuration data 1004 (e.g., in a similar manner as described with respect to step 304), and determines an asset is a critical asset (e.g., in a similar manner as described with respect to step 306).

In step 1102, attack path data is received, the attack path data is associated with a potential cyber-attack corresponding to the first asset. For example, attack path analyzer 1002 receives attack path data 1006. In accordance with an embodiment attack path data 1006 is associated with potential cyber-attacks corresponding to asset types (or other properties of) the first asset, e.g., Asset A. For instance, in accordance with an embodiment, attack path analyzer 1002 receives attack path data 1006 responsive to asset identifier 128 determining the first asset is a critical asset. In this context, attack paths corresponding to critical assets are further analyzed. Alternatively, attack path data 1006 comprises all of (or a portion of) attack path data accessible to attack path analyzer 1002 (also referred to as a “attack data” herein). In accordance with an embodiment, attack path analyzer 1002 determines if Asset A is the target of attack paths in attack path data 1006 and selectively filters out attack paths where Asset A is not the target. Alternatively, attack path analyzer 1002 selectively receives (e.g., only) attack path data 1006 where Asset A is the target. For instance, attack path analyzer 1002 in an embodiment accesses a data store that stores attack path data and identifies attack path data 1006 for attacks targeting Asset A. By selectively filtering and/or receiving attack path data for attacks targeting a determined critical asset, embodiments of attack path analyzer 1002 reduce the attack paths to be analyzed for determining a level of risk to the asset, thereby reducing compute time and compute resources expended during analysis.

In step 1104, a level of risk with respect to the first asset and the potential cyberattack is determined. In embodiments, the level of risk correlates to the likelihood the first asset is to be targeted by a cyberattack. A high level of risk indicates the first asset is more likely to be targeted by a cyberattack than an asset with a lower level of risk. In implementations, an asset has a higher level of risk if it is available to the public, has a weak or outdated password, has access to or stores sensitive data, has access to special computing components (e.g., GPUs, NPUs, etc.), has access to a closed network, and/or has other features or is in a computing environment with features that a malicious entity would utilize in conducting a cyberattack. In some embodiments, a level of risk is determined for a particular type of cyberattack (e.g., the cyberattack described by attack path data 1006). In other embodiments, a level of risk is determined for any type of cyberattack.

With continued reference to step 1104, a non-limiting example is described with respect to FIG. 10. In this example, attack path analyzer 1002 determines a level of risk with respect to Asset A and a potential cyber-attack based on attack path data 1006 (and the indication 1008 of Asset A being a critical asset). For instance, suppose Asset A is a virtual machine exposed to the internet and access to sensitive data. In this example, attack path analyzer 1002 determines the level of risk to Asset A satisfies a risk criterion (e.g., surpasses a risk threshold). As shown in FIG. 10, attack path analyzer 1002 provides a risk signal 1010 indicative of the determined level of risk to prioritization action performer 130, and flowchart 1100 continues in a similar manner as described with respect to step 308 of flowchart 300 of FIG. 3. For instance, in accordance with an embodiment, prioritization action performer 130 of FIG. 2 receives risk signal 1010 and performs prioritization action 224 based on the determined level of risk. For instance, if a critical asset has a heightened level of risk, prioritization action performer 130 prioritizes protective actions performed with respect to the critical asset (e.g., over protective actions performed with respect to critical assets of lower levels of risk and/or actions performed with respect to non-critical assets). In accordance with an embodiment, a security vulnerability is identified based on the level of risk and/or the analysis results (e.g., by attack path analyzer 1002, prioritization action perform 130, or another component of asset analysis and protection system 106). In this context, some embodiments of components of asset analysis and protection system 106 can perform prioritization actions to attempt to remediate the identified security vulnerabilities. Additional details regarding removing security vulnerabilities are described with respect to FIGS. 19 and 20, as well as elsewhere herein.

By analyzing potential attack paths to an asset, embodiments of asset analysis and protection system 106 are able to automatically identify critical assets, levels of risks to those assets, and responsively perform a prioritization action based on the level of risk. In this manner, asset analysis and protection system 106 of FIG. 10 can remediate security vulnerabilities (e.g., by alerting a user to the security vulnerability, by performing an action to remediate the vulnerability, and/or by causing another component of an associated system to remediate the vulnerability), thereby improving system security.

### IV. Protective Action Embodiments

Embodiments of asset analysis and protection system 106 operate in various manners to perform prioritization actions. For instance, in some embodiments, asset analysis and protection system 106 determines a protective action to be performed (or to recommended to be performed) with respect to a critical asset. An example of a protective action includes, but is not limited to, identifying a security vulnerability (e.g., identifying a flaw in a configuration of an asset, identifying a potential open/back door, etc.), remediating a security vulnerability (e.g., fixing a flaw in configuration of an asset (e.g., by reconfiguring the asset), removing an open door or back door of an asset (e.g., closing a secure shell (SSH) port of the asset, disable public access to a storage, disable anonymous access to a storage, etc.), etc.), preemptively implementing a security feature (e.g., protecting access to the asset by requiring proof of a user account's secret to access the asset, enabling multi-factor authentication with respect to the asset, etc.), resetting a user account's password, rotating secrets/keys of a user account or access policy, and/or any other action asset analysis protection system 106 may perform (or cause to be performed, or recommend to be performed) with respect to a critical asset.

Implementations of asset analysis and protection system 106 are configured in various ways to cause protective actions to be performed, in embodiments. For instance, FIG. 12 shows a block diagram of a system 1200 for causing a protective action to be performed, in accordance with an example embodiment. System 1200 comprises asset analysis and protection system 106 and application 110, as described with respect to FIG. 1, as well as a user environment 1204. User environment 1204 is a computing environment of the user associated with application 110. In accordance with an embodiment, user environment 1204 is hosted by server infrastructure 108 of FIG. 1. As shown in FIG. 12, user environment 1204 comprises an asset manager 1206 and assets 1208 and 1210. Asset manager 1206 is configured to manage assets within user environment 1204 (e.g., in response to instruction signal(s) 1212 received from application 110). For instance, in accordance with an embodiment, asset manager 1206 is a resource manager of server infrastructure 108 (not shown in FIG. 1) that is configured to create, remove, modify, and/or otherwise manage assets within user environment 1204 (e.g., by management signals 1216 and 1218, and the like). Assets 1208 and 1210 are example assets created by (or otherwise for) the user account associated with user environment 1204. While only two assets are shown in user environment 1204, it is contemplated herein that a user environment may comprise fewer (e.g., one) or more (e.g., more than two, tens, hundreds, thousands, or even greater) numbers of assets.

As also shown in FIG. 12, asset analysis and protection system 106 comprises asset identifier 128 and prioritization action performer 130, as described with respect to FIG. 1, as well as an asset protector 1202. In order to better understand the operation of asset analysis and protection system 106 comprising asset protector 1202, FIG. 12 is described with respect to FIG. 13. FIG. 13 shows a flowchart 1300 of a process for causing a protective action to be performed, in accordance with an example embodiment. In an embodiment, asset analysis and protection system 106 of FIG. 12 operates according to the steps of flowchart 1300. Note not all steps of flowchart 1300 need be performed in all embodiments. Further structural and operational embodiments will be apparent to persons skilled in the relevant art(s) based on the following descriptions of FIGS. 12 and 13.

Flowchart 1300 begins with steps 302-308, as described with respect to flowchart 300 of FIG. 3. For example, asset identifier 128 of FIG. 12 receives configuration data 1220 from (or otherwise associated with) asset manager 1206, configuration data 1222 from (or otherwise associated with) asset 1208, and configuration data 1224 from (or otherwise associated with) asset 1210 (e.g., in a similar manner as described with respect to step 302), analyzes the configuration data (e.g., in a similar manner as described with respect to step 304), and determines an asset is a critical asset (e.g., in a similar manner as described with respect to step 306). For instance, suppose asset identifier 128 determines asset 1210 is a critical asset. In this context, prioritization action performer 130 performs a prioritization action with respect to asset 1210. For instance, as shown in FIG. 12, prioritization action performer 130 provides prioritization signal 1228 to asset protector 1202 and flowchart 1300 continues to step 1302.

In step 1302, a protective action is determined based on the analysis result. For example, asset protector 1202 determines a protective action based on an analysis result included in prioritization signal 1228. In implementations, asset protector 1202 determines the protective action based on the type of critical asset, properties of the critical asset, attack paths the critical asset may be targeted by, security vulnerabilities of the critical asset, and/or any other information and/or analysis result corresponding to the critical asset.

In step 1304, the protective action is caused to be performed with respect to the first asset. For example, asset protector 1202 performs a protective action with respect to the first asset, e.g., asset 1210 in the running example described with respect to FIG. 12. As shown in FIG. 12, asset protector 1202 may perform various protective actions with respect to asset 1210. For instance, asset protector 1202 in accordance with an embodiment transmits a signal 1230A to application 110 that causes application 110 to display a recommended protective action to be performed with respect to asset 1210, a summary of a protective action already performed (or in the process of being performed) with respect to asset 1210, and/or any other information associated with asset 1210 and (e.g., potential) protective actions determined by asset protector 1202.

In an alternative embodiment, asset protector 1202 transmits an action signal 1230B to asset manager 1206 that causes asset manager 1206 to perform an action with respect to asset 1210 and/or user environment 1204. Action signal 1230B, in embodiments, comprises instructions to mitigate security vulnerability of asset 1210 and/or its environment, instructions to implement a security measure with respect to asset 1210 and/or its environment, instructions to re-configure asset 1210 and/or its environment, and/or otherwise perform an action based on the protective action determined by asset protector 1202. In another alternative embodiment, asset protector 1202 transmits a protection signal 1230C to asset 1210 that causes asset 1210 to perform an action (e.g., to resolve a vulnerability, to increase security, etc.) and/or that sets a property and/or other configuration of asset 1210.

Thus, several examples of automatic performance of a protective action have been described with respect to FIGS. 12 and 13. In some embodiments, asset protector 1202 determines whether or not a user account associated with the asset has enabled an automatic protection feature (e.g., by a selection made in a settings interface of the user account, by a configuration made by a developer of the cloud service that hosts the asset, and/or the like). In implementations of this alternative, asset protector 1202 determines if the user account has enabled automatic protection by locating a user identifier (ID) of the user account and an indication the feature is enabled in a table that comprises user account information, by locating a user ID of the user account in a table of user accounts that have the feature enabled, by polling the user account, and/or by performing any other action to determine whether or not such a feature has been enabled for the user account. If automatic protection has been enabled, asset protector 1202 performs steps of flowchart 1300 as described elsewhere herein. If automatic protection is not enabled, implementations of asset protector 1202 does not perform the protective action, transmits a request to a computing device of the user account for permission to perform the protective action, transmits a suggestion to perform the protective action to the computing device of the user account, and/or the like. By determining if an automatic protection feature is enabled in this manner, implementations of asset protector 1202 enable users of a cloud service environment to determine whether or not they want to allow asset analysis and protection system 106 to make changes to their assets.

In some embodiments, asset protector 1202 prioritizes protective actions performed with respect to different assets in various ways. For instance, FIG. 14 shows a flowchart 1400 of a process for prioritizing a protective action, in accordance with an example embodiment. In an embodiment, asset protector 1202 of FIG. 12 operates according to the steps of flowchart 1400. Note flowchart 1400 need not be performed in all embodiments. Further structural and operational embodiments will be apparent to persons skilled in the relevant art(s) based on the following description of FIG. 14 with respect to FIG. 12.

Flowchart 1400 comprises step 1402. In step 1402, the protective action is prioritized over another protective action corresponding to a second asset within the same computing environment as the first asset. For example, asset protector 1202 of FIG. 12 prioritizes a protective action to be performed with respect to asset 1210 over a protective action corresponding to asset 1208. In this context, asset identifier 128 identified asset 1210 and either did not identify asset 1208 as a critical asset or identified asset 1208 as a critical asset with a lower level of criticality than asset 1210 (e.g., having a lower criticality score or the like). By prioritizing protective actions based on criticality or whether an asset is determined critical at all, embodiments of asset protector 1202 enable efficient use of compute resources in resolving security vulnerabilities or otherwise protecting assets that present risk to a user's computing environment, present risk to a user's sensitive data, and/or are otherwise deemed important/critical to a user's computing environment.

Example embodiments of asset protector 1202 have been described with respect to FIGS. 12-14. As described herein, asset protector 1202 (e.g., automatically) performs a protective action with respect to a critical asset. In some implementations, asset protector 1202 is granted permissions (e.g., by a user of the computing environment) to automatically perform certain actions (but, in some further implementations, not all). In this context, a user of application 110 may interact with application 110 to manage which type of actions asset protector 1202 is permitted to perform automatically. For instance, as a non-limiting example, a user may allow asset protector 1202 to automatically apply password protection to an asset but may not allow asset protector 1202 to lock assets (without review and instruction by the user interacting with application 110, in a further example). In this context, asset analysis and protection system 106 provides flexibility in security measures utilizing automatic asset protection. Furthermore, this flexibility prevents asset protector 1202 from performing a protective action that would interfere with a user's utilization of the computing environment in a manner that (e.g., negatively) impacts the user experience (e.g., beyond a degree deemed acceptable by the user).

### V. Embodiments Regarding User Interfaces

As described herein, embodiments of asset analysis and protection systems perform prioritization actions and/or protective actions. In some embodiments, an asset analysis and protection system causes an action, an identifier of an asset, and/or other information to be displayed in a user interface of an application (e.g., a user interface of a user's (e.g., a tenant's) application or a user interface of an admin application (e.g., for debugging or other administrative purposes)). For instance, in accordance with an embodiment, asset analysis and protection system 106 of FIG. 1 causes information related to an asset to be displayed in a user interface (e.g., a graphic user interface (GUI) or another type of user interface) of application 110 (not shown in FIG. 1).

Asset analysis and protection system 106 operates in various ways to cause information to be presented in a user interface, in embodiments. For instance, FIG. 15 shows a flowchart 1500 of a process for displaying an identifier of an asset in a user interface, in accordance with an example embodiment. In an embodiment, asset analysis and protection system 106 of FIG. 1 operates according to the steps of flowchart 1500. Note flowchart 1500 need not be performed in all embodiments. Further structural and operational embodiments will be apparent to persons skilled in the relevant art(s) based on the following descriptions of FIG. 15 with respect to FIG. 1.

Flowchart 1500 begins with step 1502. In step 1502, a user interface of a computing device is caused to display an identifier of the first asset. For example, prioritization action performer 130 causes an identifier of an asset determined to be a classified asset (e.g., Asset A in the example described with respect to FIG. 3, as well as elsewhere herein) to be displayed in a user interface of user computing device 102. Examples of identifiers of the asset include, but are not limited to, a (e.g., natural language) name of the asset, an asset ID number (or alphanumeric ID) of the asset, and/or another type of identifier that uniquely identifies the critical asset. In examples, prioritization action performer 130 (or another component of asset analysis and protection system 106) causes information in addition to the identifier. For instance, in some embodiments, asset analysis and protection system 106 (or a component thereof) causes a reasoning for why the asset was determined to be a critical asset to be displayed in the user interface, a recommended protective action to be performed with respect to the critical asset, actions performed with respect to the critical asset, a location (e.g., within the environment or geographically) of the asset, properties of the asset, and/or any other information associated with the asset.

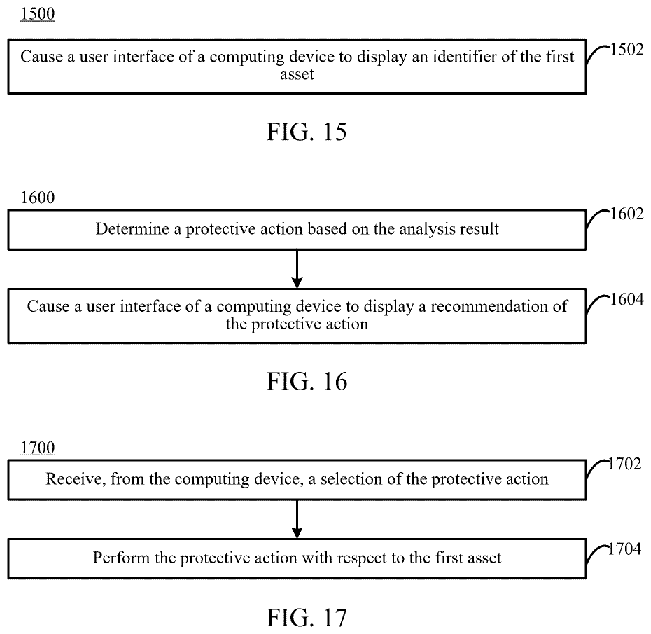

As discussed above (as well as elsewhere herein), asset analysis and protection system 106, in some embodiments, operates in a manner to cause various information to be displayed in a user interface. Furthermore, in some embodiments (e.g., as described with respect to FIGS. 12-14), asset analysis and protection system 106 determines protective actions that may be performed with respect to a critical asset. It is further contemplated herein that asset analysis and protection system 106, in some implementations, causes information regarding such protective actions to be displayed in a user interface. In this context, asset analysis and protection system 106 operates in various ways to cause such information to be displayed in a user interface. For instance, FIG. 16 shows a flowchart 1600 of a process for recommending a protective action, in accordance with an example embodiment. In an embodiment, asset analysis and protection system 106 of FIG. 12 operates according to the steps of flowchart 1600. Note not all steps of flowchart 1600 need be performed in all embodiments. Further structural and operational embodiments will be apparent to persons skilled in the relevant art(s) based on the following descriptions of FIG. 16 with respect to FIG. 12.

Flowchart 1600 begins with step 1602, which is a further example of step 1302 of flowchart 1300 of FIG. 13, in an embodiment. In step 1602, a protective action is determined based on the analysis result. For example, asset protector 1202 determines a protective action based on an analysis result in a similar manner as described with respect to step 1302 of flowchart 1300 of FIG. 13.

In step 1604, a user interface of a computing device is caused to display a recommendation of the protective action. For example, asset protector 1202 transmits action signal 1230A to cause a user interface of application 110 of user computing device 102 to display a recommendation of the protective action determined in step 1604.

As discussed elsewhere herein (e.g., with respect to FIGS. 12-14, as well as elsewhere), in some embodiments, asset analysis and protection system 106 performs a protective action with respect to an asset. Asset analysis and protection system 106 operates in various ways to perform protective actions, in embodiments. For instance, FIG. 17 shows a flowchart 1700 of a process for performing a protective action, in accordance with an example embodiment. In an embodiment, asset analysis and protection system 106 of FIG. 12 operates according to the steps of flowchart 1700. In accordance with a further embodiment, asset analysis and protection system 106 of FIG. 12 performs one or more steps of flowchart 1700 subsequent to one or more steps of flowchart 1600. Note not all steps of flowchart 1700 need be performed in all embodiments. Further structural and operational embodiments will be apparent to persons skilled in the relevant art(s) based on the following descriptions of FIG. 17 with respect to FIG. 12.

Flowchart 1700 begins with step 1702. In step 1702, a selection of the protective action is received from the computing device. For example, suppose asset protector 1202 of FIG. 2 received a selection (or an indication thereof) of a protective action (not shown in FIG. 12) from application 110. For instance, in an example, suppose a user interacts with the user interface of application 110 to select the protective action recommended by asset protector 1202.

Flowchart 1700 continues to step 1704, which is a further embodiment of step 1304 of flowchart 1300 of FIG. 13, in an embodiment. In step 1704, the protective action is performed with respect to the first asset. For example, asset protector 1202 performs a protective action with respect to asset 1210, as described elsewhere herein (e.g., with respect to step 1304 of flowchart 1300). By performing a protective action subsequent to a selection in a user interface, such embodiments of asset protector 1202 improve a user experience by implementing suggested protective actions selected by the user interaction.

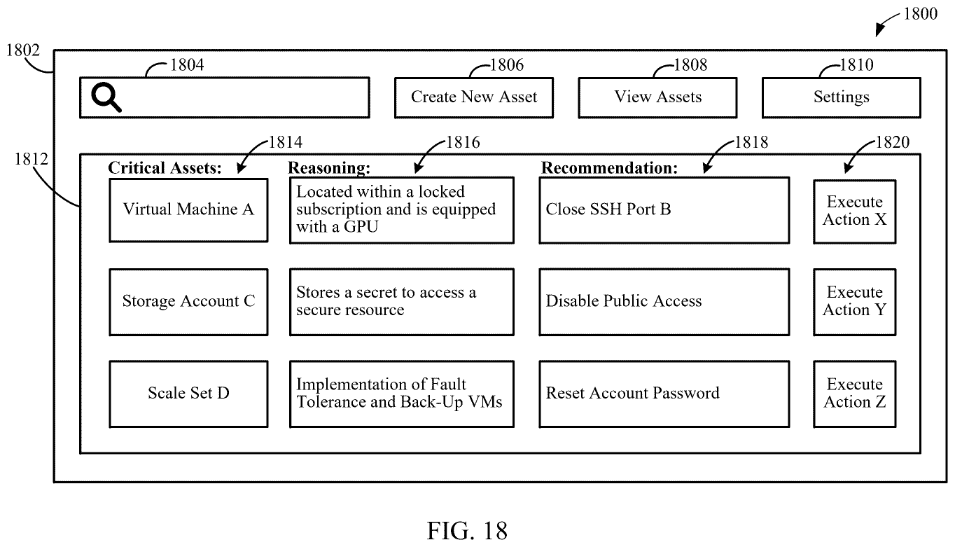

As described herein, some embodiments of asset analysis and protection system 106 cause information associated with a critical asset to be displayed in a user interface of a computing device (e.g., a user interface of application 110 of user computing device 102). Implementations of such user interfaces are configured in various ways. For instance, FIG. 18 shows an example of a user interface 1800 (“UI 1800”) for displaying critical assets, in accordance with an example embodiment. For instance, in accordance with an embodiment, UI 1800 is a user interface of application 110 of FIG. 1 that enables review, control, and management of assets belonging to (or otherwise manageable by) a user of user computing device 102 As shown in 1800, UI 1200 is a graphic user interface (GUI) and comprises a window 1802. Window 1802 displays graphic components of UI 1800. In embodiments, window 1802 is an application window of application 110 of FIG. 1 that comprises elements of UI 1800 (e.g., icon(s), pointer(s), sub-window(s), menu(s), scroll bar(s), button(s), etc.). For instance, as shown in FIG. 18, window 1802 displays a search bar 1804, a “create new asset” button 1806 (“create button 1806” herein), a “view assets” button 1808 (“view button 1808” herein), a “settings” button 1810, and a critical asset sub-window 1812. Search bar 1804 is a text field where a search query can be entered (e.g., to search for assets belonging to a user).

Create button 1806, view button 1808, and settings button 1810 are interactable button elements of UI 1800 that, upon interaction with by a user (or a pointer element of UI 1800 not shown in FIG. 18), causes an associated action to be performed. For instance, in accordance with an embodiment, interaction with create button 1806 causes a new window (e.g., a “create window”) to be displayed in UI 1800 that enables a user to specify properties of the asset they intend to create. In accordance with an embodiment, interaction with view button 1808 causes a new window (e.g., an “asset window”) to be displayed in UI 1800 that shows a list of all assets associated with the user's account. In accordance with an embodiment, interaction with settings button 1810 causes a new window (e.g., a “settings window”) to be displayed in UI 1800 that shows various settings associated with the user's account and/or the manner in which information is presented in UI 1800. Depending on the implementation, such create windows, asset windows, and/or settings windows are presented as sub-windows of window 1802, drop-down menus of window 1802, and/or separate windows from 1802.

Critical asset sub-window 1812 displays information associated with assets identified as critical assets by asset analysis and protection system 106. For example, as shown in FIG. 18, critical asset sub-window 1812 displays a list of assets 1814, a list of reasonings 1816, a list of recommendations 1818, and a set of execute buttons 1820. List of assets 1814 comprise a list of assets determined by asset identifier 128 to be critical assets (e.g., in a manner as described with respect to flowchart 300 of FIG. 3 or elsewhere herein). In accordance with an embodiment, list of assets 1814 displays identifiers of critical assets. For instance, as shown in FIG. 18, list of assets 1814 displays identifiers for “Virtual Machine A”, “Storage Account C”, and “Scale Set D”. In embodiments, assets of list of assets 1814 are sorted (e.g., based on criticality scores, based on levels of risk, etc.) or unsorted (e.g., randomly). For instance, in a risk mitigation prioritization embodiment, list of assets 1814 are sorted based on levels of risk of breach via an attack path. In this context, presentation of list of assets 1814 in critical asset sub-window 1812 enables casy identification of which assets should have remediation prioritized over others.

List of reasonings 1816 display contributing factors to determination of a particular asset as a critical asset. For example, as shown in FIG. 18, list of reasonings 1816 indicate that Virtual Machine A was determined to be a critical asset based on it being located within a locked subscription and being equipped with a graphics processing unit (GPU), that Storage Account C was determined to be a critical asset based on its storage of a secret that enables access to a secure resource, and that Scale Set D was determined to be a critical asset based on implementation of fault tolerance protocols and the usage of back-up virtual machines. In accordance with an embodiment, summarizer 206 of FIG. 2 determines Virtual Machine A is a critical asset based on a measure of uniqueness made by asset uniqueness analyzer 204 and an environment analysis result generated by environment analyzer 206. In this context, the measure of uniqueness indicates the inclusion of a GPU has a higher cost compared to the overall cost of the user's computing environment and the environment analysis result indicates the lock applied to the subscription Virtual Machine A is included in. Furthermore, in this embodiment, summarizer 206 determines Storage Account C is a critical asset based on an asset analysis result generated by asset analyzer 202 indicating Storage Account C stores the secret. Further still, in this embodiment, summarizer 206 determines Scale Set D is a critical asset based on a measure of uniqueness for Scale Set D generated by asset uniqueness analyzer 204 that indicates Scale Set D's fault tolerance protocols and usage of back-up virtual machines correspond to a criticality of Scale Set D. In this embodiment, prioritization action performer 130 causes list of reasonings 1816 to be displayed in UI 1800.

List of recommendations 1818 display protective actions determined by asset protector 1202 to be performed with respect to the corresponding critical asset (e.g., in a manner similar to that described with respect to flowchart 1600 of FIG. 16, as well as elsewhere herein). For example, as shown in FIG. 18, list of recommendations 1818 display a recommendation to close a “SSH Port B” of Virtual Machine A, a recommendation to disable public access to Storage Account C, and a recommendation to reset an account password associated with Scale Set D. In accordance with an embodiment, asset protector 1202 determines the protective actions to be recommended with respect to each asset. In some embodiments, multiple protective actions are determined and recommended for one or more assets. In FIG. 18, set of execute buttons 1820 are interactable button elements that, upon interaction with, cause a corresponding recommended action of list of recommendations 1818 to be performed with respect to the corresponding critical asset. For instance, interaction with the “Execution Action X” button causes the SSH port B of Virtual Machine A to be closed, interaction with the “Execution Action Y” button causes public access to Storage Account C to be disabled, and interaction with the “Execute Action Z” button causes an account password of an account associated with Scale Set D to be reset (e.g., by resetting the password, rotating a secret, or opening a reset account password window). Set of execute buttons 1820 are displayed as separate buttons in FIG. 18. In an alternative embodiment, critical asset window comprises an “execute all” button that, upon interaction with, causes all recommended actions to be performed. In another alternative embodiment, each execute button of set of execute buttons 1820 comprises a checkmark (or similar) interactable element and critical asset window 1812 comprises an “execute selected” button and an “execute all” button. In this alternative, interaction with the execute selected button causes each of the actions for which a checkmark was selected to be executed and interaction with the execute all button causes all of the actions to be executed.

### VI. Automatic Remediation Embodiments

As described herein, embodiments of asset analysis and protection systems cause prioritization actions to be performed based on determination that an asset is a critical asset. Furthermore, in some embodiments, a protective action is performed with respect to a critical asset. For instance, as described with respect to FIGS. 12-14 (and elsewhere herein), some implementations of asset analysis and protection systems comprise an asset protector that determines a protective action based on an analysis of a critical asset and causes the protective action to be performed with respect to the asset. It is further contemplated herein that, alternatively to or in addition to operations performed by an asset protector of an asset analysis and protection system, components and/or subcomponents of a cloud service infrastructure (e.g., server infrastructure 108 of FIG. 1) determine and/or perform actions with respect to critical assets. For instance, a server infrastructure or a component and/or sub-component thereof operates to remediate security vulnerabilities of critical assets.

Such systems are configured in various ways to remediate security vulnerabilities. For instance, FIG. 19 shows a block diagram of a system 1900 for causing a remedial action to be performed, in accordance with an example embodiment. As shown in FIG. 19, system 1900 comprises a cloud service infrastructure 1902 and prioritization action performer 130 (as described with respect to FIG. 1). Cloud service infrastructure is an example of server infrastructure 108 of FIG. 1. As further shown in FIG. 19, cloud service infrastructure 1902 comprises a user environment 1904 (comprising an asset manager 1908 and a node 1910). Asset manager 1908 operates in a similar manner as asset manager 1206 of FIG. 12 and node 1910 is a further example of nodes 116A-116N and/or nodes 118A-118N. As further shown in FIG. 19, system 1900 comprises one or more remediation systems 1906A, 1906B, and/or 1906C. Remediation system 1906A is located within cloud service infrastructure 1902 and separate from user environment 1904, remediation system 1906B is located within user environment 1904 and separate from node 1910 (in an alternative embodiment, remediation system 1906B is incorporated within asset manager 1908), and remediation system 1906C is incorporated within node 1910. Each of remediation systems 1906A-1906C are configured to perform remedial actions, as described herein.

In order to better understand the operation of system 1900, FIG. 19 is described with respect to FIG. 20. FIG. 20 shows a flowchart 2000 of a process for causing a remedial action to be performed, in accordance with an example embodiment. In an embodiment, system 1900 of FIG. 19 operates according to the steps of flowchart 2000. Note not all steps of flowchart 2000 need be performed in all embodiments. Further structural and operational embodiments will be apparent to persons skilled in the relevant art(s) based on the following descriptions of FIGS. 19 and 20.

Flowchart 200 begins with step 2002. In step 2002, an indication that the first asset is a critical asset is transmitted to a remediation system of a computing environment comprising the first asset. For example, prioritization action performer 130 receives criticality indication signal 1914 and transmits an indication 1916A, 1916B, and/or 1916C to remediation system 1906A, 1906B, and/or 1906C, respectively. Indications 1916A, 1916B, and 1916C indicate asset 1912 is a critical asset of user environment 1904.

In step 2004, a security vulnerability of the first asset is identified by the remediation system. For example, remediation system 1906A (based on information received from asset manager 1908 and/or asset 1912), remediation system 1906B (based on information received from asset manager 1908 and/or asset 1912), and/or remediation system 1906C (based on information received from asset 1912) identify a security vulnerability of asset 1912.

In step 2006, a remedial action is performed by the remediation system to remove the security vulnerability. For example, remediation system 1906A, remediation system 1906B, and/or remediation system 1906C perform a respective remedial action to remove a security vulnerability identified for asset 1912. In this context, operation of remediation systems described herein is improved based on the automatic identification of a critical asset by an asset identification and protection system (e.g., asset identification and protection system 106) as the remediation system utilizes indications received from prioritization action performer 130 to identify critical assets and potential vulnerabilities. In some embodiments, a remedial action comprises one or more steps described with respect to prioritization actions and/or protective actions elsewhere herein. For instance, in accordance with an embodiment, a remedial action comprises identifying an action and presenting it in a user interface as a selectable option (e.g., as described with respect to FIGS. 16 and 17).

By providing an indication that the first asset is a critical asset to a corresponding remediation system, prioritization action performer 130 informs the remediation system of which assets are critical without the remediation system having to perform additional prioritization analysis, thereby improving the efficiency in which a remediation system can identify and remedy vulnerabilities of assets. In some embodiments, a remedial action is performed with respect to multiple assets (e.g., multi-factor authentication is enabled for a user identity, thereby enabling multi-factor authentication for access to all of the assets that require that user identity to access).

### VII. Example Embodiments of User Environments

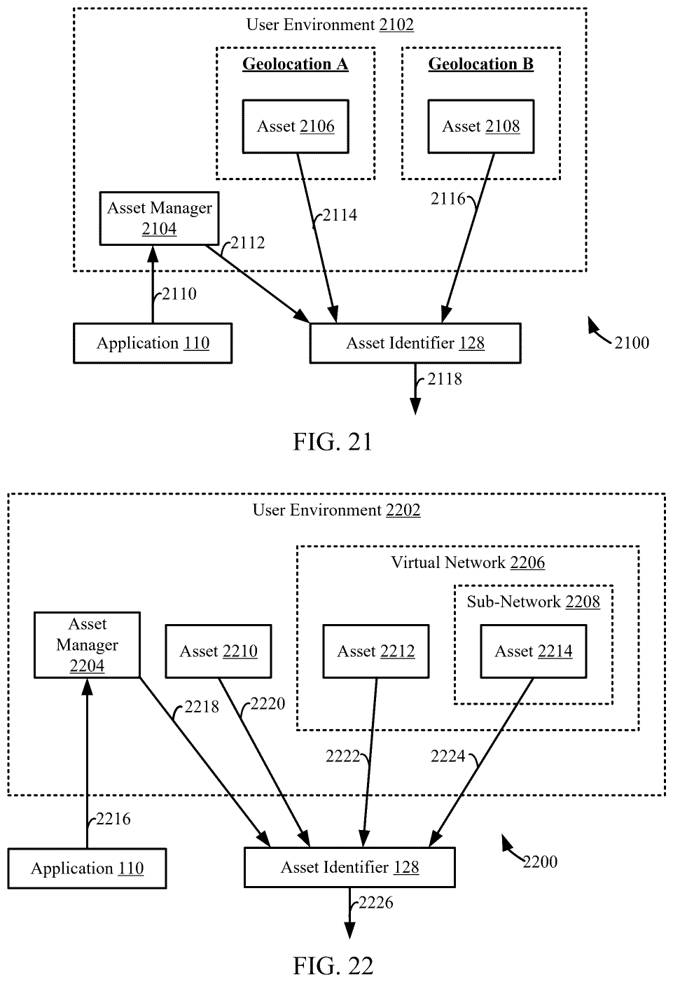

As described herein, asset analysis and protection systems are configured to analyze assets within a user's computing environment and perform prioritization actions with respect to critical assets. Embodiments of user environments are configured in various ways. In implementations, user environments comprise different types of assets (e.g., virtual machines, scale sets, ML workspaces, and/or other types of assets described herein). Asset analysis and protection systems are configured to analyze assets and their respective user environments to identify critical assets and perform prioritization actions based on the analysis results. In order to further understand the operations of asset analysis and protection systems described herein, non-limiting examples of user environments are described herein with respect to FIGS. 21 and 22.

FIG. 21 is described as follows. FIG. 21 shows a block diagram of system 2100 for identifying a critical asset, in accordance with an example embodiment. As shown in FIG. 21, system 2100 comprises application 110 and asset identifier 128 (as described with respect to FIG. 1), as well as a user environment 2102. User environment 2102 comprises an asset manager 2104, an asset 2106 located in a Geolocation A, and an asset 2108 located in a Geolocation B. Geolocation A and Geolocation B are different locations. In accordance with an embodiment, application 110 transmits instructions 2110 to asset manager 2104 to cause asset manager 2104 to manage assets 2106 and 2108. In accordance with an embodiment, asset identifier 128 generates a criticality indication signal 2118 based on environment configuration data 2112, asset configuration data 2114, and/or asset configuration data 2116.

As another non-limiting example of a user environment, FIG. 22 is described as follows. FIG. 22 shows a block diagram of system 2200 for identifying a critical asset, in accordance with another example embodiment. As shown in FIG. 22, system 2200 comprises application 110 and asset identifier 128 (as described with respect to FIG. 1), as well as a user environment 2202. User environment 2202 comprises an asset manager 2204, an asset 2210, an asset 2212 located within a virtual network 2206 of user environment 2202, and an asset 2214 located within a sub-VNET 2208 of virtual network 2206. In accordance with an embodiment, application 110 transmits instructions 2216 to asset manager 2204 to cause asset manager 2204 to manage assets 2210, 2212, and/or 2214. In accordance with an embodiment, asset identifier 128 generates a criticality signal 2226 based on environment configuration data 2218, asset configuration data 2220, asset configuration data 2222, and/or asset configuration data 2224.

### VIII. Example Computer System Implementation

Embodiments of synthetic data generation described herein are implemented in hardware, or hardware combined with one or both of software and/or firmware. For example, asset analysis and protection system 106, application 110, admin application 112, virtual machine 120, serverless function 122, ML workspace 124, scale set 126, asset manager 1206, asset 1208, asset 1210, UI 1800, recommendation system 1906A, recommendation system 1906B, recommendation system 1906C, asset manager 1908, asset 1912, asset manager 2104, asset 2106, asset 2108, asset manager 2204, asset 2210, asset 2212, asset 2214, and/or the components described therein, and/or the steps of flowcharts 300, 400A, 400B, 400C, 500, 600, 700, 800, 900, 1100, 1300, 1400, 1500, 1600, 1700, and/or 2000, are each implemented as computer program code/instructions configured to be executed in one or more processors and stored in a computer readable storage medium. Alternatively, asset analysis and protection system 106, application 110, admin application 112, virtual machine 120, serverless function 122, ML workspace 124, scale set 126, asset manager 1206, asset 1208, asset 1210, UI 1800, recommendation system 1906A, recommendation system 1906B, recommendation system 1906C, asset manager 1908, asset 1912, asset manager 2104, asset 2106, asset 2108, asset manager 2204, asset 2210, asset 2212, asset 2214, and/or the components described therein, and/or the steps of flowcharts 300, 400A, 400B, 400C, 500, 600, 700, 800, 900, 1100, 1300, 1400, 1500, 1600, 1700, and/or 2000 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

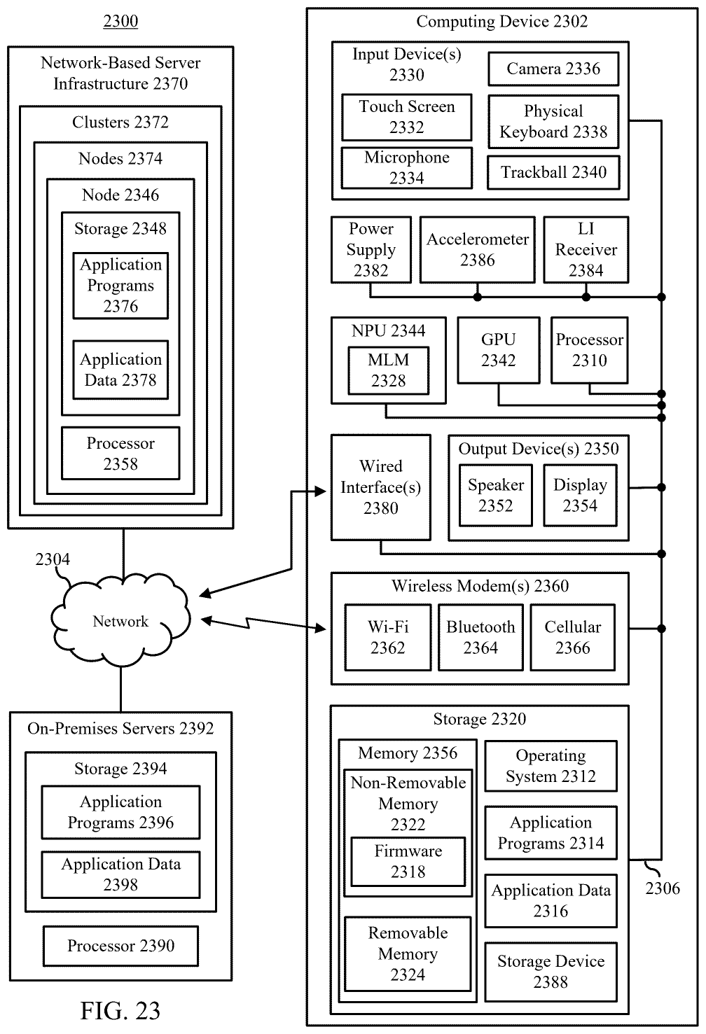

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 23. FIG. 23 shows a block diagram of an exemplary computing environment 2300 that includes a computing device 2302. Computing device 2302 is an example of user computing device 102, admin computing device 104, asset analysis and protection system 106, server infrastructure 108, node 116A, node 116N, node 118A, node 118N, and/or node 1910, which each include one or more of the components of computing device 2302. In some embodiments, computing device 2302 is communicatively coupled with devices (not shown in FIG. 23) external to computing environment 2300 via network 2304. Network 2304 is an example of network 134. Network 2304 comprises one or more networks such as local area networks (LANs), wide area networks (WANs), enterprise networks, the Internet, etc. In examples, network 2304 includes one or more wired and/or wireless portions. In some examples, network 2304 additionally or alternatively includes a cellular network for cellular communications. Computing device 2302 is described in detail as follows.

Computing device 2302 can be any of a variety of types of computing devices. Examples of computing device 2302 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 2302 is a stationary computing device such as a desktop computer, a personal computer (PC), a stationary server device, a minicomputer, a mainframe, a supercomputer, etc.

As shown in FIG. 23, computing device 2302 includes a variety of hardware and software components, including a processor 2310, a storage 2320, a graphics processing unit (GPU) 2342, a neural processing unit (NPU) 2344, one or more input devices 2330, one or more output devices 2350, one or more wireless modems 2360, one or more wired interfaces 2380, a power supply 2382, a location information (LI) receiver 2384, and an accelerometer 2386. Storage 2320 includes memory 2356, which includes non-removable memory 2322 and removable memory 2324, and a storage device 2388. Storage 2320 also stores an operating system 2312, application programs 2314, and application data 2316. Wireless modem(s) 2360 include a Wi-Fi modem 2362, a Bluetooth modem 2364, and a cellular modem 2366. Output device(s) 2350 includes a speaker 2352 and a display 2354. Input device(s) 2330 includes a touch screen 2332, a microphone 2334, a camera 2336, a physical keyboard 2338, and a trackball 2340. Not all components of computing device 2302 shown in FIG. 23 are present in all embodiments, additional components not shown may be present, and in a particular embodiment any combination of the components are present. In examples, components of computing device 2302 are mounted to a circuit card (e.g., a motherboard) of computing device 2302, integrated in a housing of computing device 2302, or otherwise included in computing device 2302. The components of computing device 2302 are described as follows.

In embodiments, a single processor 2310 (e.g., central processing unit (CPU), microcontroller, a microprocessor, signal processor, ASIC (application specific integrated circuit), and/or other physical hardware processor circuit) or multiple processors 2310 are present in computing device 2302 for performing such tasks as program execution, signal coding, data processing, input/output processing, power control, and/or other functions. In examples, processor 2310 is a single-core or multi-core processor, and each processor core is single-threaded or multithreaded (to provide multiple threads of execution concurrently). Processor 2310 is configured to execute program code stored in a computer readable medium, such as program code of operating system 2312 and application programs 2314 stored in storage 2320. The program code is structured to cause processor 2310 to perform operations, including the processes/methods disclosed herein. Operating system 2312 controls the allocation and usage of the components of computing device 2302 and provides support for one or more application programs 2314 (also referred to as “applications” or “apps”). In examples, application programs 2314 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 2310 includes one or more general processors (e.g., CPUs) configured with or coupled to one or more hardware accelerators, such as one or more NPUs 2344 and/or one or more GPUs 2342.

Any component in computing device 2302 can communicate with any other component according to function, although not all connections are shown for ease of illustration. For instance, as shown in FIG. 23, bus 2306 is a multiple signal line communication medium (e.g., conductive traces in silicon, metal traces along a motherboard, wires, etc.) present to communicatively couple processor 2310 to various other components of computing device 2302, although in other embodiments, an alternative bus, further buses, and/or one or more individual signal lines is/are present to communicatively couple components. Bus 2306 represents one or more of any of several types of bus structures, including a memory bus or memory controller, a peripheral bus, an accelerated graphics port, and a processor or local bus using any of a variety of bus architectures.

Storage 2320 is physical storage that includes one or both of memory 2356 and storage device 2388, which store operating system 2312, application programs 2314, and application data 2316 according to any distribution. Non-removable memory 2322 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 2322 includes main memory and is separate from or fabricated in a same integrated circuit as processor 2310. As shown in FIG. 23, non-removable memory 2322 stores firmware 2318 that is present to provide low-level control of hardware. Examples of firmware 2318 include BIOS (Basic Input/Output System, such as on personal computers) and boot firmware (e.g., on smart phones). In examples, removable memory 2324 is inserted into a receptacle of or is otherwise coupled to computing device 2302 and can be removed by a user from computing device 2302. Removable memory 2324 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 2388 are present that are internal and/or external to a housing of computing device 2302 and are or are not removable. Examples of storage device 2388 include a hard disk drive, a SSD, a thumb drive (e.g., a USB (Universal Serial Bus) flash drive), or other physical storage device.

One or more programs are stored in storage 2320. Such programs include operating system 2312, one or more application programs 2314, and other program modules and program data. Examples of such application programs include computer program logic (e.g., computer program code/instructions) for implementing asset analysis and protection system 106, application 110, admin application 112, virtual machine 120, serverless function 122, ML workspace 124, scale set 126, asset manager 1206, asset 1208, asset 1210, UI 1800, recommendation system 1906A, recommendation system 1906B, recommendation system 1906C, asset manager 1908, asset 1912, asset manager 2104, asset 2106, asset 2108, asset manager 2204, asset 2210, asset 2212, asset 2214, and/or the components described therein, and/or the steps of flowcharts 300, 400A, 400B, 400C, 500, 600, 700, 800, 900, 1100, 1300, 1400, 1500, 1600, 1700, and/or 2000, and/or any individual steps thereof.

Storage 2320 also stores data used and/or generated by operating system 2312 and application programs 2314 as application data 2316. Examples of application data 2316 include web pages, text, images, tables, sound files, video data, and other data. In examples, application data 2316 is sent to and/or received from one or more network servers or other devices via one or more wired or wireless networks. Storage 2320 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 2302 through one or more input devices 2330 and receives information from computing device 2302 through one or more output devices 2350. Input device(s) 2330 includes one or more of touch screen 2332, microphone 2334, camera 2336, physical keyboard 2338 and/or trackball 2340 and output device(s) 2350 includes one or more of speaker 2352 and display 2354. Each of input device(s) 2330 and output device(s) 2350 are integral to computing device 2302 (e.g., built into a housing of computing device 2302) or are external to computing device 2302 (e.g., communicatively coupled wired or wirelessly to computing device 2302 via wired interface(s) 2380 and/or wireless modem(s) 2360). Further input devices 2330 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 2354 displays information, as well as operating as touch screen 2332 by receiving user commands and/or other information (e.g., by touch, finger gestures, virtual keyboard, etc.) as a user interface. Any number of each type of input device(s) 2330 and output device(s) 2350 are present, including multiple microphones 2334, multiple cameras 2336, multiple speakers 2352, and/or multiple displays 2354.

In embodiments where GPU 2342 is present, GPU 2342 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 2342 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 2344 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 2328. In an example, NPU 2344 is configured for a data-driven parallel computing and is highly efficient at processing massive multimedia data such as videos and images and processing data for neural networks. NPU 2344 is configured for efficient handling of AI-related tasks, such as speech recognition, background blurring in video calls, photo or video editing processes like object detection, etc.

In embodiments disclosed herein that implement ML models, NPU 2344 can be utilized to execute such ML models, of which MLM 2328 is an example. For instance, where applicable, MLM 2328 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 2344 is used to train MLM 2328. To train MLM 2328, training data is that includes input features (attributes) and their corresponding output labels/target values (e.g., for supervised learning) is collected. A training algorithm is a computational procedure that is used so that MLM 2328 learns from the training data. Parameters/weights are internal settings of MLM 2328 that are adjusted during training by the training algorithm to reduce a difference between predictions by MLM 2328 and actual outcomes (e.g., output labels). In some examples, MLM 2328 is set with initial values for the parameters/weights. A loss function measures a dissimilarity between predictions by MLM 2328 and the target values, and the parameters/weights of MLM 2328 are adjusted to minimize the loss function. The parameters/weights are iteratively adjusted by an optimization technique, such as gradient descent. In this manner, MLM 2328 is generated through training by NPU 2344 to be used to generate inferences based on received input feature sets for particular applications. MLM 2328 is generated as a computer program or other type of algorithm configured to generate an output (e.g., a classification, a prediction/inference) based on received input features, and is stored in the form of a file or other data structure.

In examples, such training of MLM 2328 by NPU 2344 is supervised or unsupervised. According to supervised learning, input objects (e.g., a vector of predictor variables) and a desired output value (e.g., a human-labeled supervisory signal) train MLM 2328. The training data is processed, building a function that maps new data on expected output values. Example algorithms usable by NPU 2344 to perform supervised training of MLM 2328 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 2328 is an LLM, MLM 2328 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 2328 is trained to learn patterns from unlabeled data. For instance, in embodiments where MLM 2328 implements unsupervised learning techniques, MLM 2328 identifies one or more classifications or clusters to which an input belongs. During a training phase of MLM 2328 according to unsupervised learning, MLM 2328 tries to mimic the provided training data and uses the error in its mimicked output to correct itself (i.e., correct weights and biases). In further examples, NPU 2344 perform unsupervised training of MLM 2328 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 2344 need not necessarily be present in all ML model embodiments. In embodiments where ML models are present, any one or more of processor 2310, GPU 2342, and/or NPU 2344 can be present to train and/or execute MLM 2328.

One or more wireless modems 2360 can be coupled to antenna(s) (not shown) of computing device 2302 and can support two-way communications between processor 2310 and devices external to computing device 2302 through network 2304, as would be understood to persons skilled in the relevant art(s). Wireless modem 2360 is shown generically and can include a cellular modem 2366 for communicating with one or more cellular networks, such as a GSM network for data and voice communications within a single cellular network, between cellular networks, or between the mobile device and a public switched telephone network (PSTN). In examples, wireless modem 2360 also or alternatively includes other radio-based modem types, such as a Bluetooth modem 2364 (also referred to as a “Bluetooth device”) and/or Wi-Fi modem 2362 (also referred to as an “wireless adaptor”). Wi-Fi modem 2362 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 2364 is configured to communicate with another Bluetooth-capable device according to the Bluetooth short-range wireless technology standard(s) such as IEEE 802.15.1 and/or managed by the Bluetooth Special Interest Group (SIG).

Computing device 2302 can further include power supply 2382, LI receiver 2384, accelerometer 2386, and/or one or more wired interfaces 2380. Example wired interfaces 2380 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 2380 of computing device 2302 provide for wired connections between computing device 2302 and network 2304, or between computing device 2302 and one or more devices/peripherals when such devices/peripherals are external to computing device 2302 (e.g., a pointing device, display 2354, speaker 2352, camera 2336, physical keyboard 2338, etc.). Power supply 2382 is configured to supply power to each of the components of computing device 2302 and receives power from a battery internal to computing device 2302, and/or from a power cord plugged into a power port of computing device 2302 (e.g., a USB port, an A/C power port). LI receiver 2384 is useable for location determination of computing device 2302 and in examples includes a satellite navigation receiver such as a Global Positioning System (GPS) receiver and/or includes other type of location determiner configured to determine location of computing device 2302 based on received information (e.g., using cell tower triangulation, etc.). Accelerometer 2386, when present, is configured to determine an orientation of computing device 2302.

Note that the illustrated components of computing device 2302 are not required or all-inclusive, and fewer or greater numbers of components can be present as would be recognized by one skilled in the art. In examples, computing device 2302 includes one or more of a gyroscope, barometer, proximity sensor, ambient light sensor, digital compass, etc. In an example, processor 2310 and memory 2356 are co-located in a same semiconductor device package, such as being included together in an integrated circuit chip, FPGA, or system-on-chip (SOC), optionally along with further components of computing device 2302.

In embodiments, computing device 2302 is configured to implement any of the above-described features of flowcharts herein. Computer program logic for performing any of the operations, steps, and/or functions described herein is stored in storage 2320 and executed by processor 2310.

In some embodiments, server infrastructure 2370 is present in computing environment 2300 and is communicatively coupled with computing device 2302 via network 2304. Server infrastructure 2370, when present, is a network-accessible server set (e.g., a cloud-based environment or platform). As shown in FIG. 23, server infrastructure 2370 includes clusters 2372. Each of clusters 2372 comprises a group of one or more compute nodes and/or a group of one or more storage nodes. For example, as shown in FIG. 23, cluster 2372 includes nodes 2374. Each of nodes 2374 are accessible via network 2304 (e.g., in a “cloud-based” embodiment) to build, deploy, and manage applications and services. In examples, any of nodes 2374 is a storage node that comprises a plurality of physical storage disks, SSDs, and/or other physical storage devices that are accessible via network 2304 and are configured to store data associated with the applications and services managed by nodes 2374.

Each of nodes 2374, as a compute node, comprises one or more server computers, server systems, and/or computing devices. For instance, a node 2374 in accordance with an embodiment includes one or more of the components of computing device 2302 disclosed herein. Each of nodes 2374 is configured to execute one or more software applications (or “applications”) and/or services and/or manage hardware resources (e.g., processors, memory, etc.), which are utilized by users (e.g., customers) of the network-accessible server set. In examples, as shown in FIG. 23, nodes 2374 includes a node 2346 that includes storage 2348 and/or one or more of a processor 2358 (e.g., similar to processor 2310, GPU 2342, and/or NPU 2344 of computing device 2302). Storage 2348 stores application programs 2376 and application data 2378. Processor(s) 2358 operate application programs 2376 which access and/or generate related application data 2378. In an implementation, nodes such as node 2346 of nodes 2374 operate or comprise one or more virtual machines, with each virtual machine emulating a system architecture (e.g., an operating system), in an isolated manner, upon which applications such as application programs 2376 are executed.

In embodiments, one or more of clusters 2372 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 2372 are included in a datacenter in a distributed collection of datacenters. In embodiments, exemplary computing environment 2300 comprises part of a cloud-based platform.

In an embodiment, computing device 2302 accesses application programs 2376 for execution in any manner, such as by a client application and/or a browser at computing device 2302.

In an example, for purposes of network (e.g., cloud) backup and data security, computing device 2302 additionally and/or alternatively synchronizes copies of application programs 2314 and/or application data 2316 to be stored at network-based server infrastructure 2370 as application programs 2376 and/or application data 2378. In examples, operating system 2312 and/or application programs 2314 include a file hosting service client configured to synchronize applications and/or data stored in storage 2320 at network-based server infrastructure 2370.

In some embodiments, on-premises servers 2392 are present in computing environment 2300 and are communicatively coupled with computing device 2302 via network 2304. On-premises servers 2392, when present, are hosted within an organization's infrastructure and, in many cases, physically onsite of a facility of that organization. On-premises servers 2392 are controlled, administered, and maintained by IT (Information Technology) personnel of the organization or an IT partner to the organization. Application data 2398 can be shared by on-premises servers 2392 between computing devices of the organization, including computing device 2302 (when part of an organization) through a local network of the organization, and/or through further networks accessible to the organization (including the Internet). Furthermore, in examples, on-premises servers 2392 serve applications such as application programs 2396 to the computing devices of the organization, including computing device 2302. Accordingly, in examples, on-premises servers 2392 include storage 2394 (which includes one or more physical storage devices such as storage disks and/or SSDs) for storage of application programs 2396 and application data 2398 and include a processor 2390 (e.g., similar to processor 2310, GPU 2342, and/or NPU 2344 of computing device 2302) for execution of application programs 2396. In some embodiments, multiple processors 2390 are present for execution of application programs 2396 and/or for other purposes. In further examples, computing device 2302 is configured to synchronize copies of application programs 2314 and/or application data 2316 for backup storage at on-premises servers 2392 as application programs 2396 and/or application data 2398.

Embodiments described herein may be implemented in one or more of computing device 2302, network-based server infrastructure 2370, and on-premises servers 2392. For example, in some embodiments, computing device 2302 is used to implement systems, clients, or devices, or components/subcomponents thereof, disclosed elsewhere herein. In other embodiments, a combination of computing device 2302, network-based server infrastructure 2370, and/or on-premises servers 2392 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 2320. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per sc. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 2314) are stored in storage 2320. Such computer programs can also be received via wired interface(s) 2360 and/or wireless modem(s) 2360 over network 2304. Such computer programs, when executed or loaded by an application, enable computing device 2302 to implement features of embodiments discussed herein. Accordingly, such computer programs represent controllers of the computing device 2302.

Embodiments are also directed to computer program products comprising computer code or instructions stored on any computer-readable medium or computer-readable storage medium. Such computer program products include the physical storage of storage 2320 as well as further physical storage types.

### IX. Additional Exemplary Embodiments

A system is described herein, the system comprises an asset identifier and a prioritization action performer. The asset identifier: receives configuration data associated with a first asset, generates an analysis result based on an analysis of the configuration data, and determines the first asset is a critical asset based on the analysis result. The prioritization action performer performs a prioritization action based on the determination that the first asset is a critical asset.

In a further embodiment of the foregoing system, wherein the asset identifier and the prioritization action performer are integrated into an asset analysis and protection sub-system.

In a further embodiment of the foregoing system, wherein the asset identifier further: scans a computing environment comprising the first asset; and detects a change in the computing environment based on said scanning.

In a further embodiment of the foregoing system, wherein the configuration data comprises: configuration data of the first asset; configuration data of a second asset, wherein the first and second assets are in the same group of assets; or configuration data of a computing environment comprising the first asset.

In a further embodiment of the foregoing system, wherein to generate the analysis result, the asset identifier: generates an asset analysis result based on an analysis of the configuration data of the first asset; measures a level of uniqueness between the first asset and the second asset; or generates an environment analysis result based on an analysis of the configuration data of the computing environment.

In a further embodiment of the foregoing system, wherein to determine the first asset is a critical asset, the asset identifier determines the measure of uniqueness satisfies a uniqueness criterion.

In a further embodiment of the foregoing system, wherein to generate the environment analysis result, the asset identifier determines an asset lock is applied to the first asset, and to determine the first asset is a critical asset, the asset identifier determines the first asset is a critical asset based on the asset lock.

In a further embodiment of the foregoing system, wherein to generate the environment analysis result, the asset identifier determines the first asset is subject to an immutable storage protocol, and to determine the first asset is a critical asset, the asset identifier determines the first asset is a critical asset based on the first asset being subject to the immutable storage protocol.

In a further embodiment of the foregoing system, wherein to determine the first asset is a critical asset, the asset identifier: determines a criticality score of the first asset based on the analysis result; and determines the criticality score satisfies a critical asset criterion.

In a further embodiment of the foregoing system, further comprising an attack path analyzer that: receives attack path data associated with a potential cyberattack corresponding to the first asset; and determines a level of risk with respect to the first asset and the potential cyberattack.

In a further embodiment of the foregoing system, wherein the asset identifier, the attack path analyzer, and the prioritization action performer are integrated into an asset analysis and protection sub-system.

In a further embodiment of the foregoing system, wherein to perform a prioritization action, the prioritization action performer causes a user interface of a computing device to display an identifier of the first asset.

In a further embodiment of the foregoing system, further comprising an asset protector that determines a protective action based on the analysis result.

In a further embodiment of the foregoing system, the asset identifier, the prioritization action performer, and the asset protector are integrated into an asset analysis and protection sub-system.

In a further embodiment of the foregoing system, wherein the asset protector causes the protective action to be performed with respect to the first asset.

In a further embodiment of the foregoing system, wherein the asset protector prioritizes the protective action over another protective action corresponding to a second asset within the same computing environment as the first asset.

In a further embodiment of the foregoing system, wherein the protective action comprises: resetting a user account password associated with the first asset; rotating a secret associated with the first asset; enabling multi-factor authentication with respect to the first asset; or closing a secure shell (SSH) port of the first asset.

In a further embodiment of the foregoing system, wherein the asset protector causes a user interface of a computing device to display a recommendation of the protective action.

In a further embodiment of the foregoing system, wherein the asset protector: receives, from the computing device, a selection of the protective action; and performs the protective action with respect to the first asset.

In a further embodiment of the foregoing system, to perform a prioritization action, the prioritization action performer: transmits an indication that the first asset is a critical asset to a remediation system of a computing environment comprising the first asset.

In a further embodiment of the foregoing system, the system comprises the remediation system. The remediation system: identifies a security vulnerability of the first asset and performs a remedial action to remove the security vulnerability.

In a further embodiment of the foregoing system, the system comprises a plurality of computing devices, the plurality of computing devices comprises a first computing device comprising the first asset.

In a further embodiment of the foregoing system, the first computing device comprises the second asset.

In a further embodiment of the foregoing system, the plurality of computing devices comprises a second computing device comprising the second asset.

In a further example of the foregoing system, the plurality of computing devices are a plurality of compute nodes of a server infrastructure.

In a further example of the foregoing system, the server infrastructure comprises a cloud computing service platform.

In a further example of the foregoing system, the first (and/or the second) asset is associated with a user computing environment of the cloud computing service platform.

A method is described herein. The method comprises: receiving configuration data associated with a first asset; generating an analysis result based on an analysis of the configuration data; determining the first asset is a critical asset based on the analysis result; and performing a prioritization action based on the determination that the first asset is a critical asset.

In a further embodiment of the foregoing method, the method further comprises: scanning a computing environment comprising the first asset; and detecting a change in the computing environment based on said scanning.

In a further embodiment of the foregoing method, the configuration data comprises: configuration data of the first asset; configuration data of a second asset, wherein the first and second assets are in the same group of assets; or configuration data of a computing environment comprising the first asset.

In a further embodiment of the foregoing method, said generating the analysis result comprises: generating an asset analysis result based on an analysis of the configuration data of the first asset; measuring a level of uniqueness between the first asset and the second asset; or generating an environment analysis result based on an analysis of the configuration data of the computing environment.

In a further embodiment of the foregoing method, said determining the first asset is a critical asset comprises: determining the measure of uniqueness satisfies a uniqueness criterion.

In a further embodiment of the foregoing method, said generating the environment analysis result comprises: determining an asset lock is applied to the first asset; and wherein the first asset is determined to be a critical asset based on the asset lock.

In a further embodiment of the foregoing method, said generating the environment analysis result comprises: determining the first asset is subject to an immutable storage protocol; and wherein the first asset is determined to be a critical asset based on the first asset being subject to the immutable storage protocol.

In a further embodiment of the foregoing method, said determining the first asset is a critical asset comprises: determining a criticality score of the first asset based on the analysis result; and determining the criticality score satisfies a critical asset criterion.

In a further embodiment of the foregoing method, the method further comprises: receiving attack path data associated with a potential cyberattack corresponding to the first asset; and determining a level of risk with respect to the first asset and the potential cyberattack.

In a further embodiment of the foregoing method, said performing a prioritization action comprises: causing a user interface of a computing device to display an identifier of the first asset.

In a further embodiment of the foregoing method, said performing a prioritization action comprises: determining a protective action based on the analysis result; and causing the protective action to be performed with respect to the first asset.

In a further embodiment of the foregoing method, the method further comprises: prioritizing the protective action over another protective action corresponding to a second asset within the same computing environment as the first asset.

In a further embodiment of the foregoing method, the protective action comprises: resetting a user account password associated with the first asset; rotating a secret associated with the first asset; enabling multi-factor authentication with respect to the first asset; or closing a secure shell (SSH) port of the first asset.

In a further embodiment of the foregoing method, said performing a prioritization action comprises: determining a protective action based on the analysis result; and causing a user interface of a computing device to display a recommendation of the protective action.

In a further embodiment of the foregoing method, the method further comprises: receiving, from the computing device, a selection of the protective action; and performing the protective action with respect to the first asset.

In a further embodiment of the foregoing method, said performing a prioritization action comprises: transmitting an indication that the first asset is a critical asset to a remediation system of a computing environment comprising the first asset; identifying, by the remediation system, a security vulnerability of the first asset; and performing, by the remediation system, a remedial action to remove the security vulnerability.

Another example system is described herein. In this example, the system comprises a processor and memory. The memory comprises programming instructions structured to cause the processor to perform any of the foregoing methods.

An apparatus is described herein. The apparatus comprises a processor and memory, the memory comprises programming instructions executable by the processor to perform any of the foregoing methods.

In a further embodiment of the foregoing apparatus, the apparatus is an asset analysis and protection system.

A computer-readable storage medium encoded with program instructions structured to cause a processor to perform any of the foregoing methods.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, example embodiments have been described with respect to analyzing assets with respect to a user's computing environment; however, it is also contemplated herein that embodiments may be utilized to analyze assets with respect to a sub-set of a computing environment. For instance, suppose a tenant has a group of subscriptions to a cloud service and the tenant also includes multiple sub-users (e.g., employee users) that access resources within the subscriptions. In accordance with an embodiment, an asset analysis and protection system performs any of the associated operations described herein with respect to (e.g., only) a subset of the tenant's environment (e.g., with respect to a particular sub-user's assets, with respect to assets within a subscription, with respect to a sub-user's assets within a subscription, and/or the like).

Further still, example embodiments have been described with respect to cloud computing environment. However, similar techniques may be used in an enterprise computing environment (e.g., an on-premise computing environment) or another type of networked computing environment.

Moreover, according to the described embodiments and techniques, any components of systems, computing devices, servers, applications, asset analysis and protection systems, storages, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor; and
a memory comprising programming instructions structured to cause the processor to:
receive configuration data associated with a first asset,
generate an analysis result based on an analysis of the configuration data,
determine the first asset is a critical asset based on the analysis result, and
responsive to determining the first asset is a critical asset, determine a level of risk with respect to the first asset and a potential cyberattack;
identify a security vulnerability of the first asset based on the level of risk and the analysis result; and
perform a remedial action to remove the security vulnerability.

2. The system of claim 1, wherein the programming instructions are further structured to cause the processor to:
receive attack data; and
filter the attack data based on the first asset, resulting in the attack path data.

3. The system of claim 2, wherein the programming instructions are further structured to cause the processor to receive the attack path data responsive to the first asset being determined as a critical asset.

4. The system of claim 1, wherein the configuration data comprises configuration data of the first asset and, to generate the analysis result, the programming instructions are further structured to cause the processor to:
generate an asset analysis result based on an analysis of the configuration data of the first asset.

5. The system of claim 1, wherein the configuration data comprises configuration data of the first asset and configuration data of a second asset, the first and second assets are in a same group of assets, and to generate the analysis result, the programming instructions are further structured to cause the processor to:
measure a level of uniqueness between the first asset and the second asset; and
to determine the asset is a critical asset, the programming instructions are further structured to cause the processor to:
determine the measure of uniqueness satisfies a uniqueness criterion.

6. The system of claim 1, wherein the configuration data comprises configuration data of a computing environment comprising the first asset and, to generate the analysis result, the programming instructions are further structured to cause the processor to:
generate, based on the configuration data of the computing environment, an environment analysis result indicating an asset lock is applied to the first asset; and
wherein the first asset is determined to be a critical asset based on the asset lock.

7. The system of claim 1, wherein the configuration data comprises configuration data of a computing environment comprising the first asset and, to generate the analysis result, the programming instructions are further structured to cause the processor to:
generate, based on the configuration data of the computing environment, an environmental analysis result indicating the first asset is subject to an immutable storage protocol; and
wherein the first asset is determined to be a critical asset based on the first asset being subject to the immutable storage protocol.

8. The system of claim 1, wherein to determine the first asset is a critical asset, the programming instructions are further structured to cause the processor to:
determine a criticality score of the first asset based on the analysis result; and
determine the criticality score satisfies a critical asset criterion.

9. The system of claim 1, wherein the programming instructions are further structured to cause the processor circuit to:
prioritize the remedial action over another remedial action corresponding to a second asset within the same computing environment as the first asset.

10. The system of claim 1, wherein to perform the remedial action, the programming instructions are further structured to cause the processor to:
determine a protective action based on the analysis result;
cause a user interface of a computing device to display a recommendation of the protective action;
receive, from the computing device, a selection of the protective action; and
perform the protective action with respect to the first asset.

11. A method comprising:
receiving configuration data associated with a first asset;
generating an analysis result based on an analysis of the configuration data;
determining the first asset is a critical asset based on the analysis result; and
identifying a security vulnerability of the first asset based on the analysis result; and
performing a remedial action to remove the security vulnerability.

12. The method of claim 11, further comprising:
receiving attack path data associated with a potential cyberattack corresponding to the first asset; and
determining a level of risk with respect to the first asset and the potential cyberattack, wherein the security vulnerability is identified based on the level of risk.

13. The method of claim 11, further comprising:
scanning a computing environment comprising the first asset; and
detecting a change in the computing environment based on said scanning.

14. The method of claim 11, wherein said generating the analysis result comprises:
generating an asset analysis result based on an analysis of the configuration data;
measuring a level of uniqueness between the first asset and a second asset, the first and second assets in a same group of assets; or
generating an environment analysis result based on an analysis of the configuration data.

15. The method of claim 14, wherein said generating the environment analysis result comprises:
determining an asset lock is applied to the first asset; and
wherein the first asset is determined to be a critical asset based on the asset lock.

16. The method of claim 14, wherein said generating the environment analysis result comprises;
determining the first asset is subject to an immutable storage protocol; and
wherein the first asset is determined to be a critical asset based on the first asset being subject to the immutable storage protocol.

17. The method of claim 11, further comprising:
prioritizing the remedial action over another remedial action corresponding to a second asset within the same computing environment as the first asset.

18. A computer-readable storage medium encoded with program instructions structured to cause a processor to perform a method, the method comprising:
receiving configuration data associated with a first asset;
generating an analysis result based on an analysis of the configuration data;
determining the first asset is a critical asset based on the analysis result;
responsive to said determining the first asset is a critical asset, identifying a security vulnerability of the first asset; and
responsive to identifying the security vulnerability, causing a prioritization action to be performed with respect to the first asset.

19. The computer-readable storage medium of claim 18, wherein said performing the prioritization action comprises:
identifying a security vulnerability of the first asset based on the analysis result;
performing a remedial action to remove the security vulnerability.

20. The computer-readable storage medium of claim 19. wherein said performing the prioritization action further comprises:
prioritizing the remedial action over another remedial action corresponding to a second asset within the same computing environment as the first asset.
